(19) United States
(12) Patent Application Publication
(10) Pub. No.: US 2014/0153132 A1
(43) Pub. Date: Jun. 5, 2014

(54) SPINDLE MOTOR AND DISK DRIVE APPARATUS

(71) Applicant: Nidec Corporation, Kyoto (JP)

(72) Inventors: Kazuhiro SATO, Kyoto (JP); Masahiro SHIRAISHI, Kyoto (JP); Takayuki ISHINO, Kyoto (JP); Akihiro YUDATE, Kyoto (JP); Takuro MATSUMOTO, Kyoto (JP); Toshihiro AKIYAMA, Kyoto (JP)

(73) Assignee: Nidec Corporation, Kyoto (JP)

(21) Appl. No.: 14/169,511

(22) Filed: Jan. 31, 2014

Related U.S. Application Data
(63) Continuation-in-part of application No. 13/780,447, filed on Feb. 28, 2013.
(60) Provisional application No. 61/680,817, filed on Aug. 8, 2012.

(30) Foreign Application Priority Data
Aug. 7, 2012 (JP) 2012-174570

(51) Int. Cl. H02K 5/22; G11B 19/20

(52) U.S. Cl. CPC H02K 5/225; G11B 19/2009
USPC 360/99.08; 310/71

(57) ABSTRACT

A base member of a motor includes a base through-hole extending through a bottom portion thereof. Two or more lead wires extending from coils pass through the base through-hole. Thus, as compared with a case where the lead wires pass through different base through-holes respectively, it is possible to reduce the number of the base through-holes. Accordingly, it is possible to minimize or prevent a reduction in the rigidity of the base member. Insulating sheet portions are arranged on the lower and upper surfaces of the base member. Each insulating sheet portion includes an overhang portion which overlaps with the base through-hole when seen in a plan view. The lead wires extending from the coils are led out toward the lower surface of the base member through holes, cutouts, or slits defined in the overhang portion. This makes it possible to easily distinguish the led-out lead wires from each other.

### CROSS-REFERENCE TO RELATED APPLICATIONS

This application is a Continuation-In-Part application of U.S. patent application Ser. No. 13/780,447.

### BACKGROUND OF THE INVENTION

1. Field of the Invention

The present invention relates to a spindle motor and a disk drive apparatus.

2. Description of the Related Art

A hard disk device or an optical disk device is typically equipped with a spindle motor for rotating a disk. The spindle motor includes a stationary unit fixed to a housing of a device and a rotary unit rotating together with a disk supported thereon. In the spindle motor, torque acting about a center axis is generated by magnetic fluxes generated between the stationary unit and the rotary unit, whereby the rotary unit is rotated with respect to the stationary unit.

A conventional spindle motor is disclosed in, e.g., Japanese Patent Application Publication No. 2011-114892. The spindle motor disclosed in the above-cited reference includes a base member, coils and a circuit substrate. Lead wires extending from the coils are led out via through-holes of the base member and are connected to the circuit substrate (see claim 1 of Japanese Patent Application Publication No. 2011-114892).

In this spindle motor, there is a need to electrically insulate the lead wires led out from the coils and the base member. Particularly, the spindle motor is becoming thinner and thinner in recent years. Consequently, the diameter of the lead wires making up the coils tends to become smaller. For that reason, if the lead wires having a small diameter make contact with the base member, there is a fear that the lead wires may be damaged by a light contact. Thus, it is desirable to prevent the lead wires and the base member from making contact with each other even under a tensioned state.

A conventional spindle motor is disclosed in, e.g., Japanese Patent Application Publication No. 2011-114892. The spindle motor disclosed in the above-cited reference includes a base member, coils and a circuit substrate (for example, see claim 1 of Japanese Patent Application Publication No. 2011-114892). In Japanese Patent Application Publication No. 2011-114892, three lead wires extending from the coils are connected to the circuit substrate at the lower surface side of the base member (for example, see paragraphs [0026] and [0027] of Japanese Patent Application Publication No. 2011-114892).

In a manufacturing process of the spindle motor, the three lead wires need to be distinguished from one another in order to connect the lead wires to the circuit substrate without mistake. To this end, it is conceivable that the respective lead wires are distinguished from one another by, e.g., forming three through-holes in the base member and passing the lead wires through the through-holes, respectively. However, if a plurality of through-holes corresponding to the respective lead wires is formed in the base member, the rigidity of the base member is reduced. Moreover, a wide groove for the arrangement of the lead wires needs to be formed on the lower surface of the base member. Therefore, the rigidity of the base member is further reduced by the groove.

Particularly, the spindle motor is becoming thinner and thinner in recent years. Thus, the thickness of the base member tends to become smaller. Accordingly, in order for the base member to have necessary rigidity, there is a strong technical demand to reduce the number of through-holes formed in the base member and to reduce the breadth of the groove formed on the lower surface of the base member.

### SUMMARY OF THE INVENTION

Preferred embodiments of the present invention provide a spindle motor capable of minimizing or preventing a reduction in the rigidity of a base member and capable of easily distinguishing a plurality of lead wires led out toward a lower surface of the base member from each other. A spindle motor according to one illustrative example of a preferred embodiment of the present invention includes a stationary unit and a rotary unit. The rotary unit is supported to rotate about a center axis extending up and down. The stationary unit includes a base member made of metal, an armature, and a circuit substrate. The armature is positioned above the base member. The circuit substrate is arranged on a lower surface of the base member and is electrically connected to coils of the armature. The rotary unit includes a magnet. The magnet is arranged to generate torque between the magnet and the armature. The base member includes a bottom portion, at least one base through-hole and a base groove portion. The bottom portion preferably has a ring shape. The bottom portion is positioned below the armature. The base through-hole axially extends through the bottom portion. The base groove portion is arranged on a lower surface of the bottom portion. The base groove portion extends radially outward from a lower end portion of the base through-hole. A first insulating sheet portion is arranged within the base groove portion. An adhesive agent or a sticky material is interposed between a bottom surface of the base groove portion and the first insulating sheet portion. A second insulating sheet portion is arranged on an upper surface of the bottom portion. The first insulating sheet portion or the second insulating sheet portion includes an overhang portion overlapping with a lower opening or an upper opening of the base through-hole when seen in a plan view. The overhang portion includes one or more holes, one or more cutouts, or one or more slits and the total number of the holes, the cutouts, and/or the slits preferably is two or more, through each of which at least one of lead wires extending from the coils passes. The lead wires are arranged to pass through the upper opening of the base through-hole, the overhang portion, and the lower opening of the base through-hole and are led out into the base groove portion. The lead wires extend radially outward along a lower surface of the first insulating sheet portion. The lead wires are soldered to land portions of the circuit substrate at the radial outer side of the bottom portion.

According to one illustrative preferred embodiment of the present invention, a plurality of lead wires is arranged to pass through one base through-hole. Thus, as compared with a case where the lead wires pass through different base through-holes respectively, it is possible to reduce the number of the base through-hole. As a result, it is possible to minimize or prevent a reduction in the rigidity of the base member. Furthermore, at least one of the lead wires is led out toward the lower surface of the base member through the holes, cutouts or slits of the overhang portion. This makes it possible to easily distinguish the led-out lead wires.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a partial vertical sectional view of a spindle motor according to a first preferred embodiment of the present invention.

FIG. 2 is a vertical sectional view of a disk drive apparatus according to a second preferred embodiment of the present invention.

FIG. 3 is a vertical sectional view of a spindle motor according to the second preferred embodiment of the present invention.

FIG. 4 is a partial vertical sectional view of the spindle motor according to the second preferred embodiment of the present invention.

FIG. 5 is a partial vertical sectional view of a stationary unit according to the second preferred embodiment of the present invention.

FIG. 6 is a partial bottom view of a base member according to the second preferred embodiment of the present invention.

FIG. 7 is a partial plan view of the base member according to the second preferred embodiment of the present invention.

FIG. 8 is a partial vertical sectional view of a spindle motor according to a modified example of a preferred embodiment of the present invention.

FIG. 9 is a partial vertical sectional view of a spindle motor according to a modified example of a preferred embodiment of the present invention.

FIG. 10 is a vertical sectional view of a circuit substrate according to a modified example of a preferred embodiment of the present invention.

FIG. 11 is a partial vertical sectional view of a stationary unit according to a modified example of a preferred embodiment of the present invention.

FIG. 12 is a partial bottom view of a base member according to a modified example of a preferred embodiment of the present invention.

FIG. 13 is a plan view of a first insulating sheet portion and a second insulating sheet portion according to a modified example of a preferred embodiment of the present invention.

FIG. 14 is a partial vertical sectional view of a stationary unit according to a modified example of a preferred embodiment of the present invention.

FIG. 15 is a partial vertical sectional view of a spindle motor according to a third preferred embodiment of the present invention.

FIG. 16 is a vertical sectional view of a disk drive apparatus according to a fourth preferred embodiment of the present invention.

FIG. 17 is a vertical sectional view of a spindle motor according to the fourth preferred embodiment of the present invention.

FIG. 18 is a partial vertical sectional view of the spindle motor according to the fourth preferred embodiment of the present invention.

FIG. 19 is a partial vertical sectional view of the vicinity of a base through-hole according to the fourth preferred embodiment of the present invention.

FIG. 20 is a partial bottom view of a base member according to the fourth preferred embodiment of the present invention.

FIG. 21 is a partial plan view of the base member according to the fourth preferred embodiment of the present invention.

FIG. 22 is a partial vertical sectional view of a spindle motor according to a modified example of a preferred embodiment of the present invention.

FIG. 23 is a partial bottom view of a base member according to the modified example of a preferred embodiment of the present invention.

FIG. 24 is a partial bottom view of a base member according to another modified example of a preferred embodiment of the present invention.

FIG. 25 is a partial plan view of a base member according to still another modified example of a preferred embodiment of the present invention.

FIG. 26 is a partial plan view of a base member according to a modified example of a preferred embodiment of the present invention.

FIG. 27 is a partial plan view of a base member according to still another modified example of a preferred embodiment of the present invention.

FIG. 28 is a partial plan view of a base member according to still another modified example of a preferred embodiment of the present invention.

FIG. 29 is a partial vertical sectional view of the vicinity of a base through-hole according to still another modified example of a preferred embodiment of the present invention.

FIG. 30 is a partial vertical sectional view of the vicinity of a base through-hole according to still another modified example of a preferred embodiment of the present invention.

FIG. 31 is a partial bottom view of a base member according to still another modified example of a preferred embodiment of the present invention.

### DETAILED DESCRIPTION OF THE PREFERRED EMBODIMENTS

Hereinafter, illustrative preferred embodiments of the present invention will now be described with reference to the drawings. In the subject application, the direction parallel to the center axis of a spindle motor will be referred to as “axial”. The direction orthogonal to the center axis of the spindle motor will be referred to as “radial”. The direction extending along an arc about the center axis of the spindle motor will be referred to as “circumferential”. In the subject application, the shape and positional relationship of individual components will be described under the assumption that the axial direction is an up-down direction and further that the side of an armature with respect to a base member is an upper side. However, such definition of the up-down direction is not intended to limit the in-use direction of the spindle motor and the disk drive apparatus according to the present invention.

In the subject application, the term “parallel” includes the term “substantially parallel”. The term “orthogonal” includes the term “substantially orthogonal”.

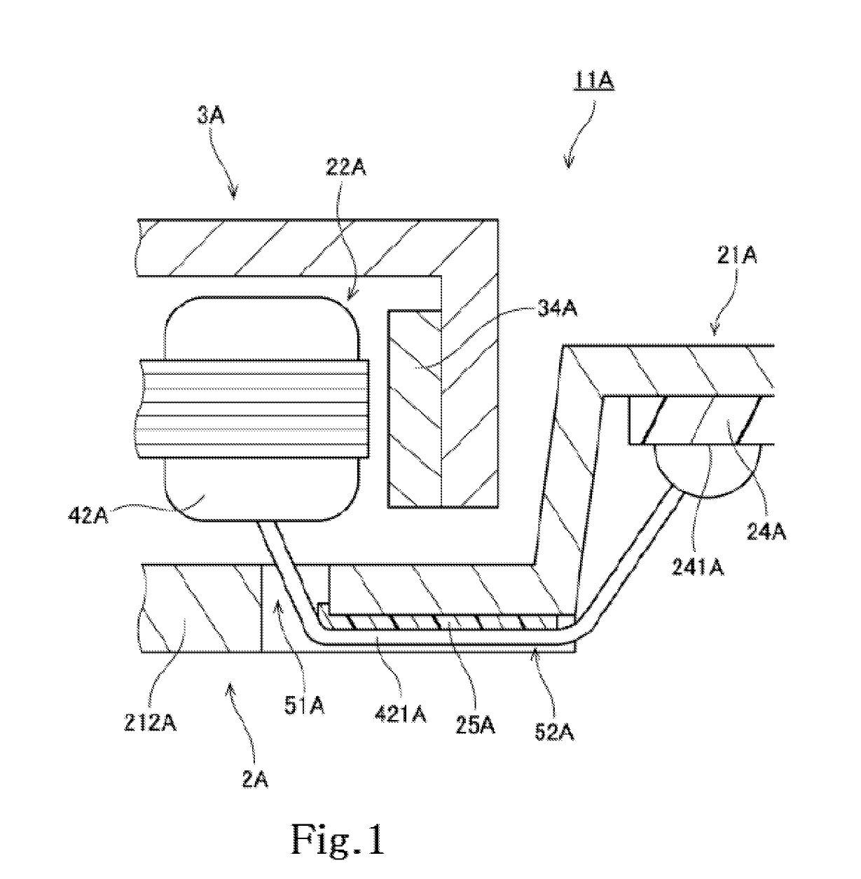

FIG. 1 is a partial vertical sectional view of a spindle motor 11A according to a first preferred embodiment of the present invention. As shown in FIG. 1, the spindle motor 11A includes a stationary unit 2A and a rotary unit 3A.

The stationary unit 2A preferably includes a base member 21A, an armature 22A, and a circuit substrate 24A. The base member 21A preferably is made of metal. The base member 21A may be made of a material such as, e.g., an aluminum alloy, a ferromagnetic or non-magnetic stainless steel, a magnesium alloy, etc. The armature 22A is positioned above the base member 21A. The circuit substrate 24A is arranged on the lower surface of the base member 21A. The circuit substrate 24A is electrically connected to the coils 42A of the armature 22A.

The rotary unit 3A is supported to rotate about a center axis extending up and down. The rotary unit 3A includes a magnet 34A. During the operation of the spindle motor 11A, torque is generated by the magnetic fluxes generated between the armature 22A and the magnet 34A.

As shown in FIG. 1, the base member 21A preferably includes a bottom portion 212A, a base through-hole 51A, and a base groove portion 52A. The bottom portion 212A is positioned below the armature 22A and extends in a ring shape. The base through-hole 51A axially extends through the bottom portion 212A. The base groove portion 52A is arranged on the lower surface of the base member 21A. The base groove portion 52A extends radially outward from the lower end portion of the base through-hole 51A.

A first insulating sheet portion 25A is preferably fixed to the bottom surface of the base groove portion 52A by, for example, an adhesive agent or a sticky material. The thickness of the first insulating sheet portion 25A is preferably smaller than the thickness of a land portion 241A of the circuit substrate 24A. Furthermore, a portion of the first insulating sheet portion 25A overlaps with a lower opening of the base through-hole 51A when seen in a plan view.

A lead wire 421A extending from each of the coils 42A is led into the base groove portion 52A via the base through-hole 51A. Moreover, the lead wire 421A extends radially outward along the lower surface of the first insulating sheet portion 25A. The lead wire 421A is soldered to the land portion 241A of the circuit substrate 24A at the radial outer side of the bottom portion 212A. For that reason, the contact between the lead wire 421A and the base member 21A is prevented by the first insulating sheet portion 25A. Accordingly, the lead wire 421A and the base member 21A are electrically insulated from each other.

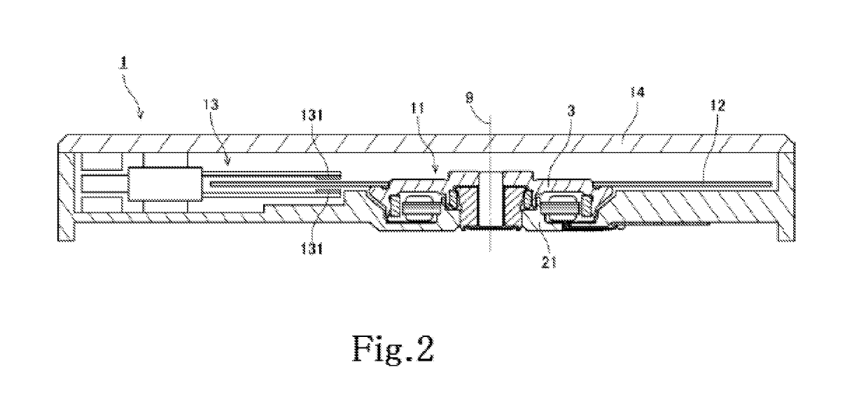

FIG. 2 is a vertical sectional view of a disk drive apparatus 1 according to a second preferred embodiment of the present invention. The disk drive apparatus 1 is preferably an apparatus for rotating, e.g., a magnetic disk 12, and performing information reading and writing tasks with respect to the magnetic disk 12. As shown in FIG. 2, the disk drive apparatus 1 preferably includes a spindle motor 11, a magnetic disk 12, an access unit 13, and a cover 14.

The spindle motor 11 supports the magnetic disk 12 and rotates the magnetic disk 12 about a center axis 9. The spindle motor 11 includes a base member 21 extending in a direction orthogonal to the center axis 9. The upper region of the base member 21 is covered with the cover 14. The rotary unit 3 of the spindle motor 11, the magnetic disk 12, and the access unit 13 are accommodated within a housing defined by the base member 21 and the cover 14. The access unit 13 is arranged to move a head 131 along the recording surface of the magnetic disk 12 and to perform information reading and writing tasks with respect to the magnetic disk 12.

The disk drive apparatus 1 may include two or more magnetic disks 12. Furthermore, the access unit 13 may perform only one of the information reading and writing tasks with respect to the magnetic disk 12.

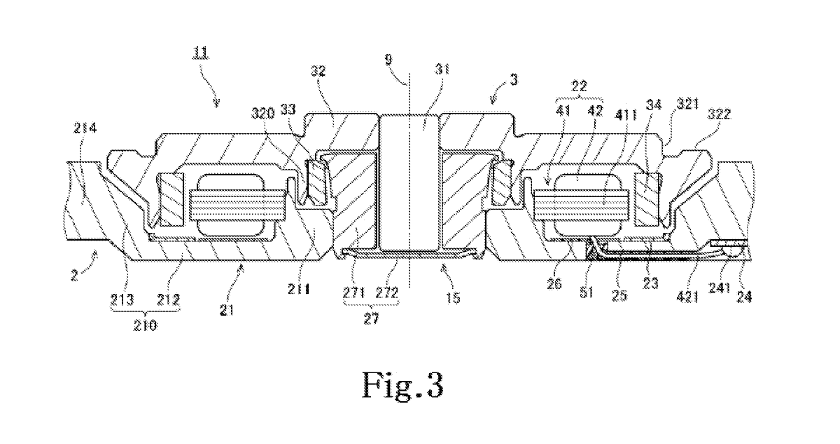

Next, description will be made on the detailed configuration of the spindle motor 11. FIG. 3 is a vertical sectional view of the spindle motor 11. As shown in FIG. 3, the spindle motor 11 includes a stationary unit 2 and a rotary unit 3. The stationary unit 2 is kept stationary with respect to the base member 21 and the cover 14. The rotary unit 3 is supported to rotate with respect to the stationary unit 2.

The stationary unit 2 of the present preferred embodiment includes a base member 21, an armature 22, a thrust yoke 23, a circuit substrate 24, a first insulating sheet portion 25, a second insulating sheet portion 26, and a stationary bearing unit 27.

The base member 21 is arranged below the rotary unit 3, the magnetic disk 12 and the access unit 13 to extend in a direction orthogonal to the center axis 9. The base member 21 can be obtained by casting metal, e.g., aluminum. Alternatively, the base member 21 may be obtained by other methods such as, for example, cutting, pressing, etc. In addition, the base member 21 may be provided by a plurality of members.

The base member 21 preferably includes a cylinder portion 211, an inner bottom portion 212, a ring-shaped wall portion 213, and an outer bottom portion 214. The inner bottom portion 212 is arranged below the armature 22 to extend in a ring shape. Moreover, the inner bottom portion 212 is positioned more downward than the outer bottom portion 214. The cylinder portion 211 extends upward in a cylindrical or substantially cylindrical shape from the radial inner edge portion of the inner bottom portion 212. The ring-shaped wall portion 213 extends obliquely such that the height thereof becomes larger as the ring-shaped wall portion 213 goes radially outward from the radial outer edge of the inner bottom portion 212. The outer bottom portion 214 extends further radially outward from the radial outer edge of the ring-shaped wall portion 213.

The armature 22, the thrust yoke 23, the second insulating sheet portion 26, and a portion of the rotary unit 3 are accommodated at the upper side of the inner bottom portion 212 and at the radial inner side of the ring-shaped wall portion 213. Thus, the outer bottom portion 214 is arranged at the same height or substantially at the same height as the armature 22 and a portion of the rotary unit 3. The circuit substrate 24 is arranged radially outward of the inner bottom portion 212 and the ring-shaped wall portion 213. For that reason, the armature 22 and the circuit substrate 24 do not axially overlap with each other. Accordingly, the circuit substrate 24 can be arranged higher than the bottom surface of the inner bottom portion 212. This makes it possible to reduce the axial thickness of the spindle motor 11 as a whole.

The armature 22 preferably includes a stator core 41 and a plurality of coils 42. The stator core 41 and the coils 42 are positioned above the inner bottom portion 212. The stator core 41 preferably is defined by a steel plate laminate obtained by axially stacking electromagnetic steel plates, e.g., silicon steel plates, one above another. The stator core 41 is fixed to the outer circumferential surface of the cylinder portion 211. Moreover, the stator core 41 preferably includes a plurality of teeth 411 extending radially outward. The teeth 411 are preferably arranged at a regular or substantially regular interval in the circumferential direction.

The coils 42 are defined by lead wires wound around the respective teeth 411. The coils 42 of the present preferred embodiment are preferably defined by three lead wires 421 arranged to supply three-phase currents therethrough. The end portions of the respective lead wires 421 are led out toward the lower surface of the base member 21 via a base through-hole 51 defined in the inner bottom portion 212.

The thrust yoke 23 is a ring-shaped member arranged on the upper surface of the inner bottom portion 212. The thrust yoke 23 is preferably made of a magnetic material, e.g., an electromagnetic steel plate (e.g., a silicon steel plate), a ferromagnetic stainless steel plate (e.g., SUS430), a cold-rolled steel plate (e.g., SPCC or SPCE), etc. The thrust yoke 23 is preferably positioned below the magnet 34 to be described later. A magnetic attraction force is generated between the thrust yoke and the magnet 34. Thus, the rotary unit 3 is attracted toward the stationary unit 2.

The circuit substrate 24 is arranged on the lower surface of the outer bottom portion 214. Three land portions 241 including exposed copper foils are preferably arranged on the lower surface of the circuit substrate 24. The three lead wires 421 led out from the base through-hole 51 are respectively soldered to respective ones of the three land portions 241. Thus, the circuit substrate 24 and the coils 42 are electrically connected to each other. An electric current which drives the spindle motor 11 is supplied from an external power source to the coils 42 through the circuit substrate 24.

The number of the lead wires 421 led out from the base through-hole 51 is not limited to three. For example, four lead wires may be led out from the base through-hole 51.

A flexible printed substrate having flexibility is preferably used as the circuit substrate 24 of the present preferred embodiment. Use of the flexible printed substrate makes it possible to arrange the circuit substrate 24 along the irregularities of the lower surface of the base member 21. Use of the flexible printed substrate also makes it possible to reduce the axial thickness of the circuit substrate 24 as compared with other substrates. Accordingly, it is possible to further reduce the axial thickness of the spindle motor 11.

The stationary bearing unit 27 includes a sleeve 271 and a cap 272. The sleeve 271 is arranged around the below-mentioned shaft 31 to axially extend in a cylindrical or substantially cylindrical shape. The lower portion of the sleeve 271 is accommodated radially inward of the cylinder portion 211 of the base member 21 and is preferably fixed to the cylinder portion 211 by, e.g., an adhesive agent. The inner circumferential surface of the sleeve 271 is radially opposed to the outer circumferential surface of the shaft 31. The cap 272 closes the lower opening of the sleeve 271. The sleeve 271 may be defined by a plurality of members, for example.

The rotary unit 3 of the present preferred embodiment preferably includes a shaft 31, a hub 32, a ring-shaped member 33, and a magnet 34.

The shaft 31 is arranged radially inward of the sleeve 271 to extend in the axial direction. The shaft 31 is preferably made of metal, e.g., ferromagnetic or non-magnetic stainless steel. The upper end portion of the shaft 31 protrudes more upward than the upper surface of the sleeve 271.

The hub 32 extends radially outward from the peripheral edge of the upper end portion of the shaft 31. The inner circumferential portion of the hub 32 is fixed to the upper end portion of the shaft 31. As shown in FIG. 3, the hub 32 of the present preferred embodiment includes a ring-shaped projection 320 protruding downward. The ring-shaped member 33 is fixed to the inner circumferential surface of the ring-shaped projection 320. The inner circumferential surface of the ring-shaped member is radially opposed to the outer circumferential surface of the sleeve 271.

The hub 32 preferably includes a first holding surface 321 having a cylindrical or substantially cylindrical shape and a second holding surface 322 extending radially outward from the lower end portion of the first holding surface 321. The inner circumferential portion of the magnetic disk 12 makes contact with at least a portion of the first holding surface 321. Furthermore, the lower surface of the magnetic disk 12 makes contact with at least a portion of the second holding surface 322. Thus, the magnetic disk 12 is held in place.

A lubricant is provided between the shaft 31 and the stationary bearing unit 27, between the hub 32 and the stationary bearing unit 27 and between the ring-shaped member 33 and the stationary bearing unit 27. The liquid level of the lubricant is positioned between the sleeve 271 and the ring-shaped member 33. For example, polyol ester-based oil or diester-based oil is preferably used as the lubricant. The shaft 31 is rotatably supported with respect to the stationary bearing unit 27 through the lubricant.

That is to say, in the present preferred embodiment of the present invention, a bearing mechanism 15 preferably is defined by the sleeve 271 and the cap 272, which are members belonging to the stationary unit 2; the shaft 31, the hub 32 and the ring-shaped member 33, which are members belonging to the rotary unit 3; and the lubricant present between these members. The bearing mechanism 15 is accommodated within the cylinder portion 211. The rotary unit 3 is supported on the bearing mechanism 15 and is rotated about the center axis 9.

The magnet 34 is preferably arranged radially outward of the armature 22 and is fixed to the hub 32. The magnet 34 of the present preferred embodiment preferably has an annular or substantially annular shape. The inner circumferential surface of the magnet 34 is radially opposed to the radial outer end surfaces of the teeth 411. The inner circumferential surface of the magnet 34 is alternately magnetized with N-poles and S-poles along the circumferential direction.

A plurality of magnets may be used in place of the annular magnet 34. In case of using a plurality of magnets, they may be arranged along the circumferential direction so that N-poles and S-poles can be alternately lined up.

In the spindle motor 11 described above, if a drive current is supplied to the coils 42 via the circuit substrate 24, magnetic fluxes are generated in the teeth 411. Then, circumferential torque is generated by the magnetic fluxes acting between the teeth 411 and the magnet 34. As a result, the rotary unit 3 is rotated about the center axis 9 with respect to the stationary unit 2. The magnetic disk 12 supported on the hub 32 is rotated about the center axis 9 together with the rotary unit 3.

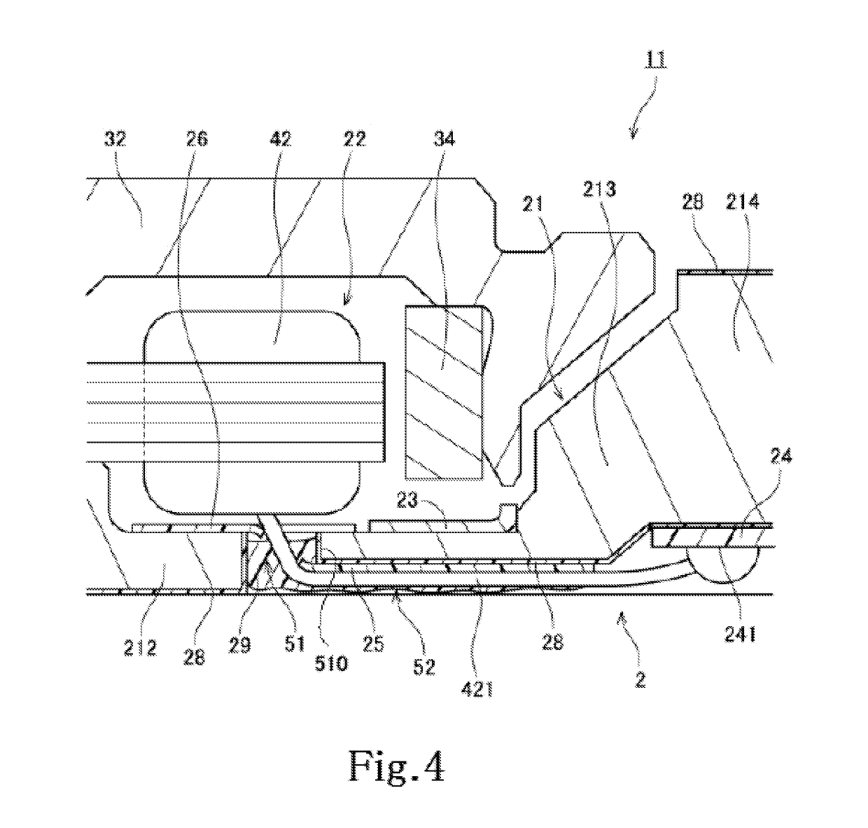

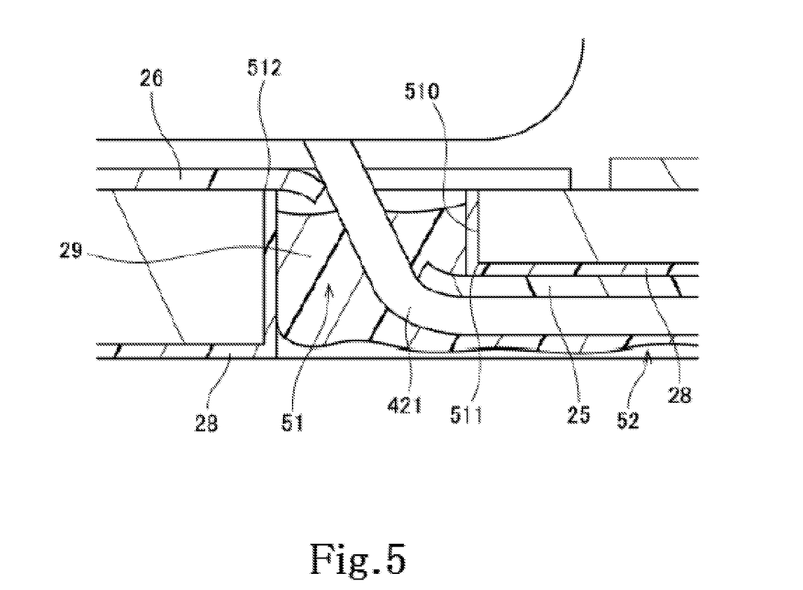

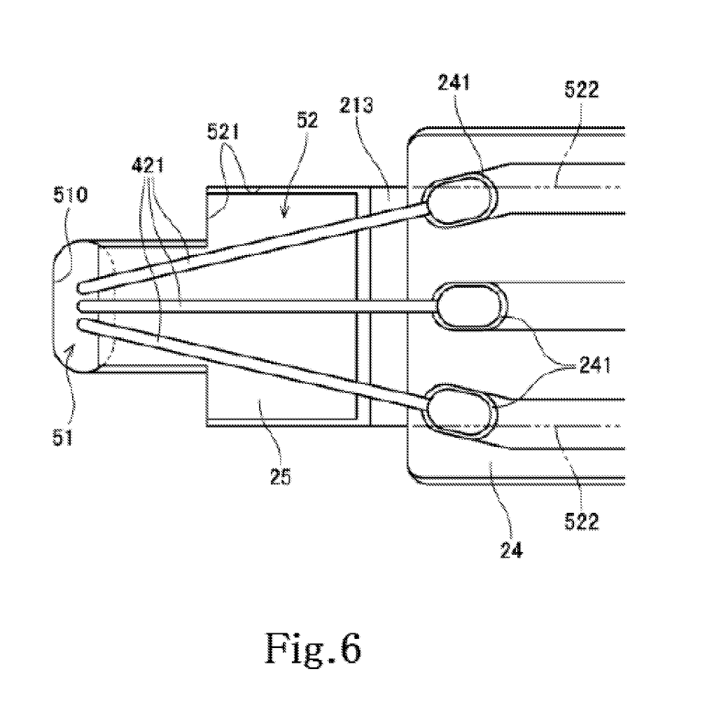

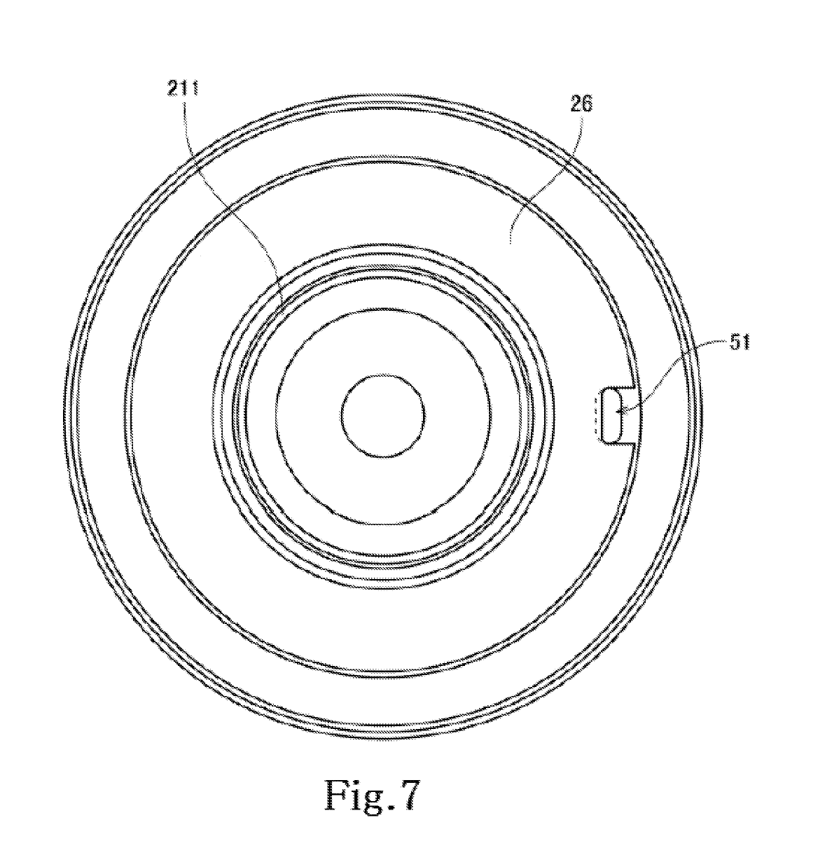

Next, description will be made on the routes of the lead wires 421 extending from the coils 42 to the land portions 241. FIG. 4 is a partial sectional view of the spindle motor 11, which includes each of the routes of the lead wires 421 extending from the coils 42 to the land portions 241. FIG. 5 is a vertical sectional view showing a portion of each of the routes of the lead wires 421 on an enlarged scale. FIG. 6 is a partial bottom view of the base member 21, which includes the routes of the lead wires 421. FIG. 7 is a partial plan view of the base member 21. In FIG. 6, an adhesive agent 29 is omitted from the illustration. In FIG. 7, the adhesive agent 29 and the lead wires 421 are omitted from the illustration. In the following description, reference will be made to FIG. 3 and, if appropriate, FIGS. 4 through 7.

At least a portion of the surface of the base member 21 is preferably covered with an insulating portion 28 to electrically insulate at least the portion of the base member 21. The insulating portion 28 is preferably formed by electrocoating, e.g., a resin as an insulating material. Alternatively, the insulating portion 28 may be formed by powder coating. In the present preferred embodiment, as shown in FIGS. 4 and 5, at least the lower surface of the inner bottom portion 212, the lower surface of the ring-shaped wall portion 213, the lower surface of the outer bottom portion 214, and the upper surface of the outer bottom portion 214 are covered with the insulating portion 28.

The base member 21 includes a base through-hole 51. The base through-hole 51 is arranged below the armature 22 to axially extend through the inner bottom portion 212. A tubular surface 510 of the base member 21 defining the base through-hole is preferably covered with the insulating portion 28. Furthermore, a base groove portion 52 extending in the radial direction is preferably defined on the lower surfaces of the inner bottom portion 212 and the ring-shaped wall portion 213. The base groove portion 52 extends radially outward from the lower end portion of the base through-hole 51 toward the circuit substrate 24. In other words, the lower end portion of the base through-hole 51 is opened into the base groove portion 52. The bottom surface and the wall surfaces defining the base groove portion 52 are preferably covered with the insulating portion 28.

A first insulating sheet portion 25 is preferably arranged within the base groove portion 52. The first insulating sheet portion 25 is fixed to the bottom surface of the base groove portion 52 preferably by an adhesive agent or a sticky material, for example. In addition, a second insulating sheet portion 26 is arranged on the upper surface of the inner bottom portion 212. The second insulating sheet portion 26 is preferably fixed to the upper surface of the inner bottom portion 212 by an adhesive agent or a sticky material, for example.

The first insulating sheet portion 25 and the second insulating sheet portion 26 are preferably defined by an insulating material, e.g., a resin such as polyethylene terephthalate (PET) or the like. The thickness of the first insulating sheet portion 25 and the second insulating sheet portion 26 is preferably larger than the thickness of the insulating portion 28 and is smaller than the thickness of the circuit substrate 24 at the land portions 241. At least a portion of the surface of the base member 21 may be covered with a metal plating layer. In this case, the thickness of the first insulating sheet portion 25 is preferably larger than the thickness of the metal plating layer.

The second insulating sheet portion 26 is interposed between the inner bottom portion 212 and the coils 42. This prevents the base member 21 and the coils 42 from making contact with each other. Thus, the base member 21 and the coils 42 are electrically insulated from each other. The interposition of the second insulating sheet portion 26 makes it possible to bring the inner bottom portion 212 and the coils 42 into close proximity with each other in the axial direction. This further reduces the axial thickness of the spindle motor 11.

As shown in FIGS. 4 and 5, each of the lead wires 421 extends toward the base through-hole 51 from the upper side of the inner bottom portion 212 and from the radial inner side of the center of the base through-hole 51. Moreover, each of the lead wires 421 is led out into the base groove portion 52 via the base through-hole 51. Within the base groove portion 52, each of the lead wires 421 extends radially outward along the lower surface of the first insulating sheet portion 25. The end portion of each of the lead wires 421 is soldered to each of the land portions 241 of the circuit substrate 24 at the radial outer side of the inner bottom portion 212.

Each of the lead wires 421 led out toward the lower surface of the inner bottom portion 212 in this manner is accommodated within the base groove portion 52. The axial depth of the base groove portion 52 is larger than the sum of the thickness of the insulating portion 28, the thickness of the first insulating sheet portion 25, and the diameter of each of the lead wires 421. Thus, each of the lead wires 421 is prevented from protruding more downward than the lower surface of the inner bottom portion 212. As a result, the axial thickness of the spindle motor 11 gets reduced. The diameter of each of the lead wires 421 mentioned above denotes the diameter of a cross section including both a bare conductor of each of the lead wires 421 and a protection film covering the bare conductor.

The first insulating sheet portion 25 and the second insulating sheet portion 26 are interposed between the inner bottom portion 212 and each of the lead wires 421. This prevents the base member 21 and the lead wires 421 from making contact with each other. Thus, the base member 21 and the lead wires 421 are electrically insulated from each other. Particularly, in the present preferred embodiment, when seen in a plan view, a portion of the first insulating sheet portion 25 overlaps with the radial outer end portion of the lower opening of the base through-hole 51. Moreover, when seen in a plan view, a portion of the second insulating sheet portion 26 overlaps with the radial inner end portion of the upper opening of the base through-hole 51. This prevents the base member 21 and the lead wires 421 from making contact with each other.

In the present preferred embodiment, as shown in FIG. 5, the first insulating sheet portion 25 is interposed between a radial outer lower corner portion 511 of the tubular surface 510 defining the base through-hole 51 and each of the lead wires 421. For that reason, each of the lead wires 421 does not make contact with the lower corner portion 511 or the insulating portion 28 covering the lower corner portion 511. Moreover, the second insulating sheet portion 26 is interposed between a radial inner upper corner portion 512 of the tubular surface 510 defining the base through-hole 51 and each of the lead wires 421. For that reason, each of the lead wires 421 preferably does not make contact with the upper corner portion 512 or the insulating portion 28 covering the upper corner portion 512. Thus, stresses are prevented from concentrating on the lead wires 421. As a result, the lead wires 421 are prevented from getting damaged.

Each of the lead wires 421 led out from the coils 42 include a bare conductor and a protection film (not shown) covering the bare conductor, which is made of an insulating material. The protection film is easily damaged when it makes contact with a rigid material such as metal or the like. In the present preferred embodiment, the lead wires 421 make contact with the first insulating sheet portion 25 and the second insulating sheet portion 26 which are lower in rigidity than the metal of which the base member 21 is made. Thus, the protection film is prevented from getting damaged. Even if the protection film of each of the lead wires 421 gets damaged, there is no possibility that the lead wires 421 and the base member 21 make contact with each other. In particular, the first insulating sheet portion 25 and the second insulating sheet portion 26 are preferably made of an insulating material. This prevents electric conduction between the lead wires 421 and the base member 21.

In the present preferred embodiment, the radial inner end portion of the first insulating sheet portion 25 is positioned radially inward of the radial outer lower corner portion 511 of the tubular surface 510 defining the base through-hole 51. The radial inner end portion of the first insulating sheet portion 25 is preferably positioned near the lower corner portion 511. Moreover, the radial inner end portion of the first insulating sheet portion 25 is separated from the tubular surface 510. In other words, the radial inner end portion of the first insulating sheet portion 25 becomes a free end. The lead wires 421 make contact with the radial inner end portion of the first insulating sheet portion 25. Thus, the first insulating sheet portion 25 is bent upward at the radial inner side of the lower corner portion 511. This reduces the force generated between the first insulating sheet portion 25 and the lead wires 421. As a result, the lead wires 421 are further prevented from getting damaged.

Similarly, the end portion of the second insulating sheet portion 26 provided within the base through-hole 51 is positioned radially outward of the radial inner upper corner portion 512 of the tubular surface 510. This end portion of the second insulating sheet portion 26 is positioned near the upper corner portion 512. This end portion of the second insulating sheet portion 26 is bent downward by making contact with the lead wires 421. This reduces the force generated between the second insulating sheet portion 26 and the lead wires 421. As a result, the lead wires 421 are further prevented from getting damaged.

In the present preferred embodiment, the lead wires 421 extend from the coils 42 to the land portions 241 with little slackness. In other words, tensions are exerted on the lead wires 421. This prevents the lead wires 421 from protruding downward from the base groove portion 52. However, if tensions are exerted on the lead wires 421, the protection films covering the surfaces of the lead wires 421 get damaged with ease. In the present preferred embodiment, however, the external forces applied to the lead wires 421 are reduced by the first insulating sheet portion 25 and the second insulating sheet portion 26. As a result, the lead wires 421 are prevented from being damaged.

In the present preferred embodiment, the first insulating sheet portion 25 and the circuit substrate 24 are provided by different members. The radial outer end portion of the first insulating sheet portion 25 is positioned radially inward of the radial inner end portion of the circuit substrate 24. The lower surface of the ring-shaped wall portion 213 is positioned between the radial outer end portion of the first insulating sheet portion 25 and the radial inner end portion of the circuit substrate 24. That is to say, in the present preferred embodiment, the first insulating sheet portion 25 is not arranged on the lower surface of the ring-shaped wall portion 213 as a slant surface or a step surface. This makes it possible to prevent the first insulating sheet portion 25 from being separated downward from the base member 21.

In the present preferred embodiment, as shown in FIGS. 4 through 6, the radial inner end portion of the first insulating sheet portion 25 is positioned radially outward of the radial inner end portion of the tubular surface 510 defining the base through-hole 51. Furthermore, the axial thickness of the base member 21 at the radial inner side of the base through-hole 51 is larger than the axial thickness of the base groove portion of the base member 21. This increases the rigidity of the base member 21 at the radial inner side of the base through-hole 51.

In the present preferred embodiment, as shown in FIG. 6, three lead wires 421 extend radially or substantially radially from the lower end portion of the base through-hole 51. The circumferential width of each of the base groove portion 52 and the first insulating sheet portion 25 is widened radially outward in a stepwise fashion. This prevents the lead wires 421 and the wall surfaces 521 of the base groove portion 52 from making contact with each other. In the present preferred embodiment, as shown in FIG. 6, a portion of the wall surfaces 521 of the base groove portion 52 makes contact with the first insulating sheet portion 25 in the radial direction. Thus, the first insulating sheet portion 25 is radially positioned in place.

Referring to FIG. 6, a pair of imaginary lines 522 extending radially outward from the opposite wall surfaces 521 of the radial outer end portion of the base groove portion 52 is indicated by double-dot chain lines. In the present preferred embodiment, the center of the respective land portions 241 is positioned between the imaginary lines 522. This makes it possible to prevent the lead wires 421 extending toward the respective land portions 241 from making contact with the wall surfaces 521 of the base groove portion 52.

As shown in FIG. 6, each of the land portions 241 of the present preferred embodiment preferably has an elliptical or substantially elliptical shape having a major axis and a minor axis when seen in a plan view. The major axes of the respective land portions 241 are arranged to extend along the substantially radial lines diverging from the base through-hole 51. This makes it possible to prolong the length of the lead wires 421 overlapping with the respective land portions 241. For that reason, it becomes easy to solder the lead wires 421 to the respective land portions 241.

As shown in FIGS. 4 and 5, the stationary unit 2 of the present preferred embodiment preferably further includes an adhesive agent 29 as a sealing material. The base through-hole 51 is sealed by the adhesive agent 29. This prevents gasses from flowing through the base through-hole 51. As a result, it is possible to enhance the air-tightness of the disk drive apparatus 1. In addition, the lead wires 421 are fixed by the adhesive agent 29. As a result, the lead wires 421 are prevented from protruding more downward than the lower surface of the inner bottom portion 212.

In the present preferred embodiment, the adhesive agent 29 is arranged not only within the base through-hole 51 but also within the base groove portion 52. This makes it possible to fix the lead wires 421 by the adhesive agent 29 over a broader range. For that reason, the lead wires 421 are prevented from protruding more downward than the lower surface of the inner bottom portion 212.

In the present preferred embodiment, the axial depth of the base groove portion 52 is larger than the sum of the thickness of the insulating portion 28, the thickness of the first insulating sheet portion 25, the diameter of the lead wire 421, and the thickness of the adhesive agent 29. Thus, the adhesive agent 29 is prevented from extruding downward from the base groove portion 52.

Other sealing materials may be used in place of the adhesive agent 29. For example, a resin material other than the adhesive agent may be used as a sealing material.

While illustrative preferred embodiments of the present invention have been described above, the present invention is not limited to the aforementioned preferred embodiments.

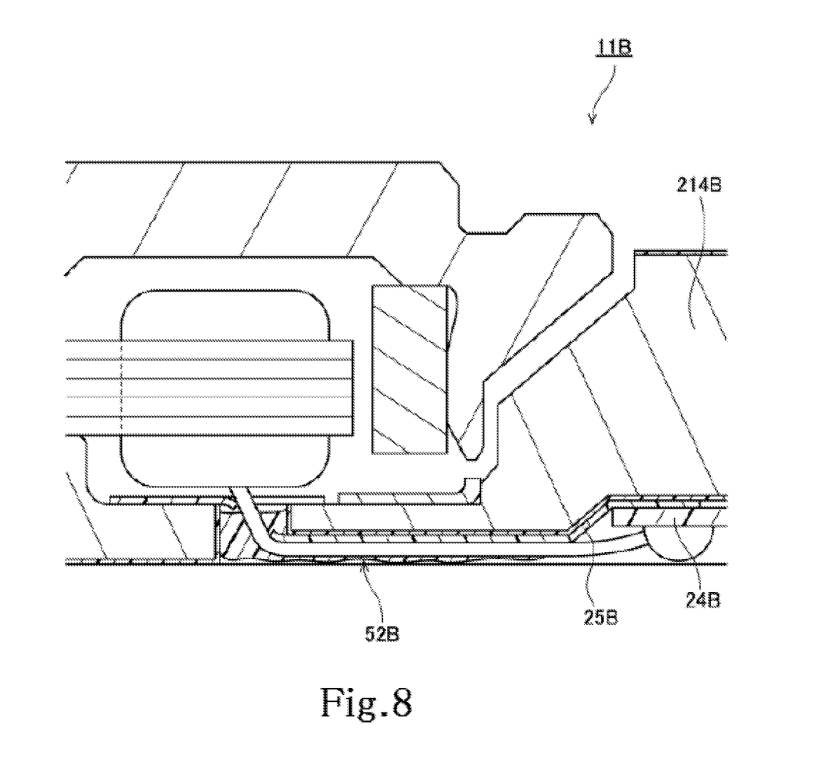

FIG. 8 is a partial vertical sectional view of a spindle motor 11B according to one modified example of a preferred embodiment of the present invention. In the example shown in FIG. 8, the first insulating sheet portion 25B extends to the lower surface of the outer bottom portion 214B within the base groove portion 52B. A portion of the radial outer region of the first insulating sheet portion 25B is covered with the circuit substrate 24B. As a result, a portion of the lower surface of the first insulating sheet portion 25B makes contact with a portion of the upper surface of the circuit substrate 24B. Thus, by use of the circuit substrate 24B thicker than the first insulating sheet portion 25B, it is possible to prevent the first insulating sheet portion 25B from being separated downward from the base member.

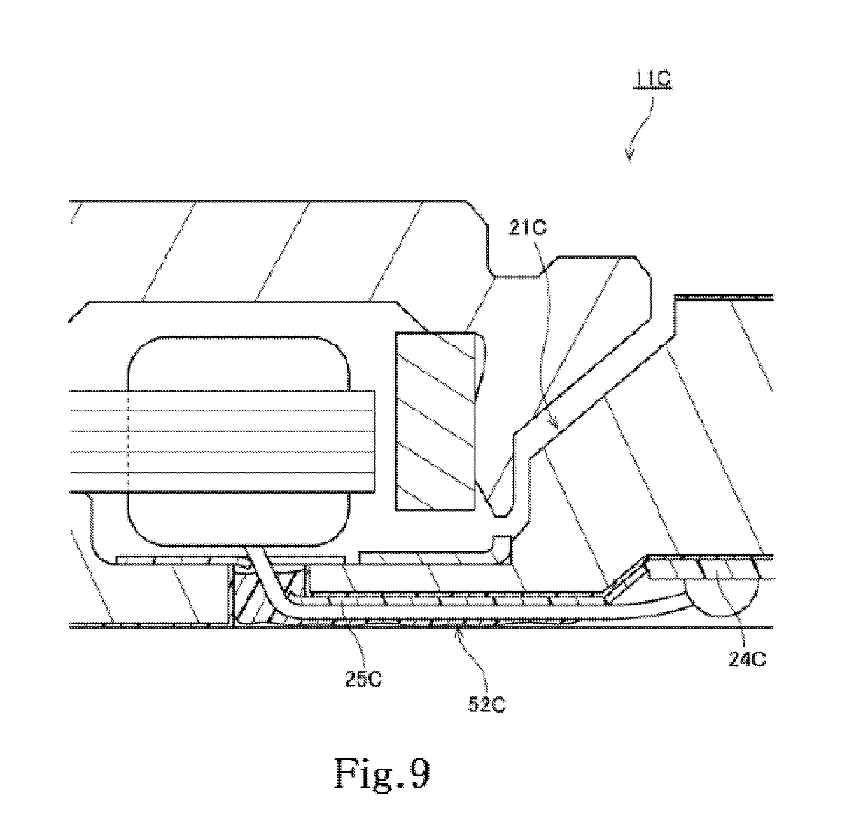

FIG. 9 is a partial vertical sectional view of a spindle motor 11C according to another modified example of a preferred embodiment of the present invention. In the example shown in FIG. 9, a portion of the circuit substrate 24C extends into the base groove portion 52C so as to define the first insulating sheet portion 25C. This makes it possible to handle the circuit substrate 24C and the first insulating sheet portion 25C as a single member during assembly. For that reason, it is possible to reduce the number of steps required to attach the circuit substrate 24C and the first insulating sheet portion 25C to the base member 21C.

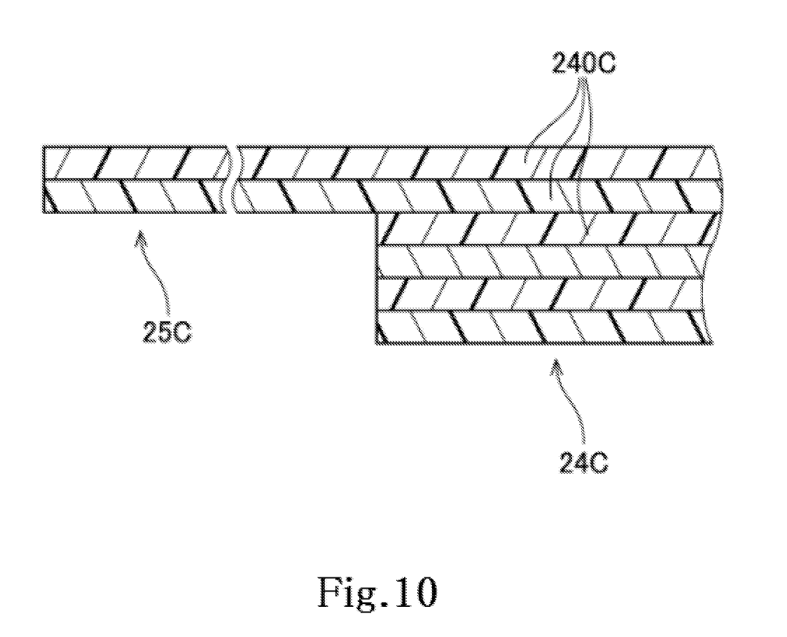

FIG. 10 is a partial vertical sectional view of the circuit substrate 24C. As shown in FIG. 10, the circuit substrate 24C is preferably defined by a plurality of thin films 240C axially stacked one above another. A portion of the thin films 240C extends toward the base groove portion 52C so as to define a first insulating sheet portion 25C. The first insulating sheet portion 25C provided in this manner is axially thinner than the first insulating sheet portion 25C defined by all the thin films 420C of the circuit substrate 24C. Accordingly, it is possible to make the spindle motor 11C thinner in the axial direction.

More specifically, two layers, i.e., a sticky material layer and a polyimide layer, of the thin films 240C defining the circuit substrate 24C may be caused to extend into the base groove portion 52C, thereby defining the first insulating sheet portion 25C. This makes it possible to define the first insulating sheet portion 25C with a minimum number of layers. Accordingly, it is possible to make the first insulating sheet portion 25C thinner in the axial direction.

If the first insulating sheet portion 25 and the circuit substrate 24 are provided by different members as in the second preferred embodiment described above, it is possible to freely select the material of the first insulating sheet portion 25. In other words, the material of the first insulating sheet portion 25 is not limited to the material of the circuit substrate 24. This is desirable in that a suitable material can be used as the material of the first insulating sheet portion 25.

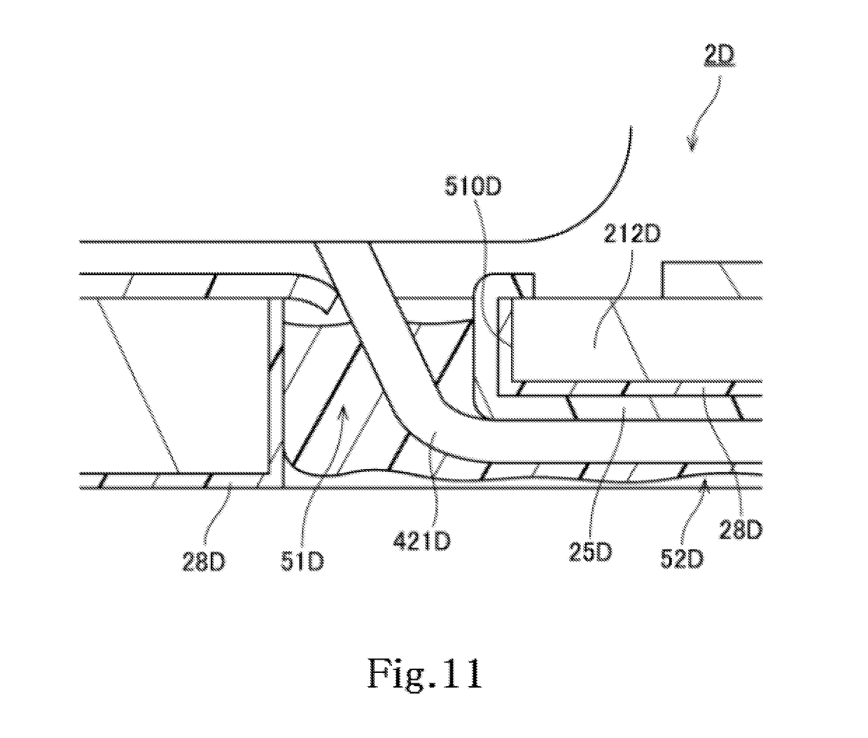

FIG. 11 is a partial vertical sectional view of a stationary unit 2D according to a further modified example of a preferred embodiment of the present invention. In the example shown in FIG. 11, the first insulating sheet portion 25D extends upward from the radial inner end portion of the base groove portion 52D along the tubular surface 510D defining the base through-hole 51D through which the lead wires 421D extend. The end portion of the first insulating sheet portion 25D reaches the upper surface of the inner bottom portion 212D. Moreover, the first insulating sheet portion 25D makes contact with the insulating portion 28D covering the tubular surface 510D. In this manner, the end portion of the first insulating sheet portion 25D may not be necessarily positioned within the base through-hole 51D.

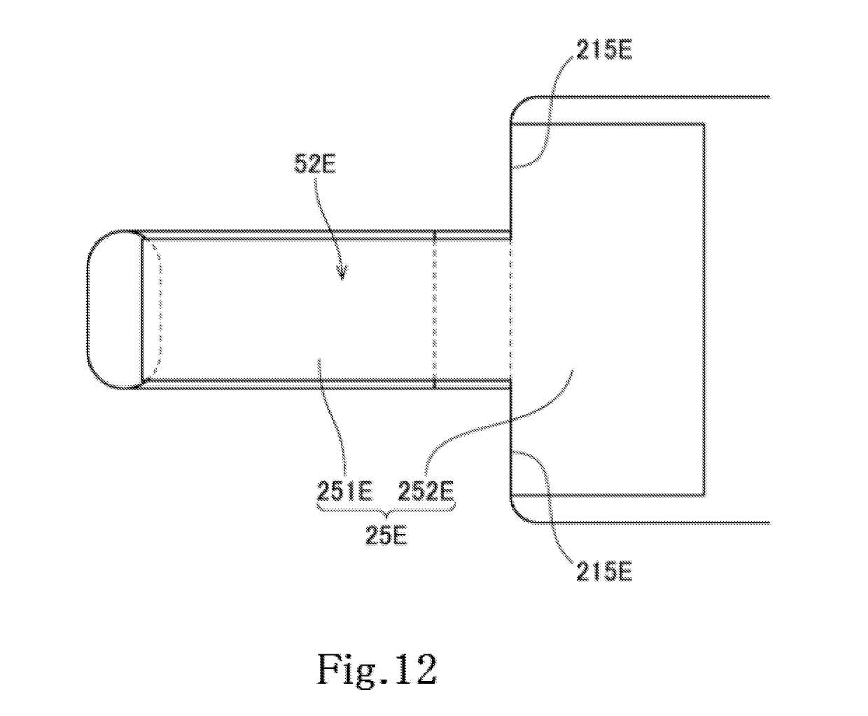

FIG. 12 is a partial bottom view of a base member according to a still further modified example of a preferred embodiment of the present invention. In the example shown in FIG. 12, the first insulating sheet portion 25E preferably includes an inner sheet portion 251E and an outer sheet portion 252E. The inner sheet portion 251E is positioned within the base groove portion 52E. The outer sheet portion 252E is positioned radially outward of the base groove portion 52E. The circumferential width of the outer sheet portion 252E is larger than the circumferential width of the inner sheet portion 251E and the base groove portion 52E.

In this case, a pair of end surfaces 215E circumferentially extending from the radial outer end portion of the base groove portion 52E is preferably radially opposed to the radial inner edge portion of the outer sheet portion 252E. For that reason, the first insulating sheet portion 25E can be radially positioned in place through the use of the end surfaces 215E.

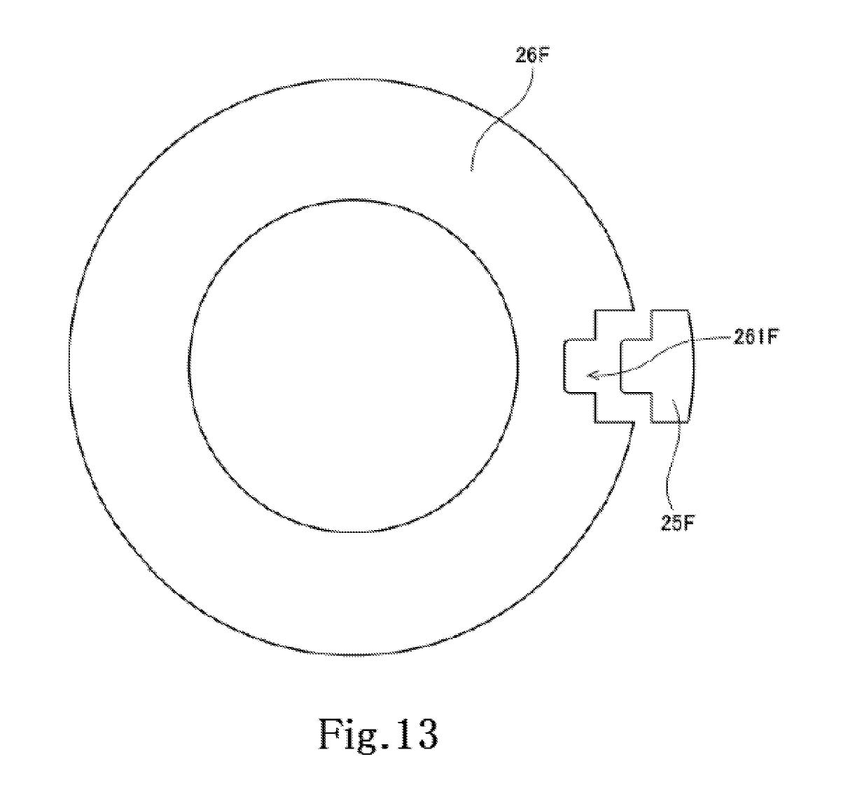

FIG. 13 is a plan view of a first insulating sheet portion 25F and a second insulating sheet portion 26F according to a yet another further modified example of a preferred embodiment of the present invention. The second insulating sheet portion 26F shown in FIG. 13 preferably includes a cutout 261F depressed radially inward from the radial outer edge thereof. After the manufacture of the spindle motor 11, the radial inner end portion of the cutout 261F is positioned in the upper end portion of the base through-hole. In the example shown in FIG. 13, the first insulating sheet portion 25F is formed through the use of a portion which has been cut away to form the cutout 261F of the second insulating sheet portion 26F. The shape of the first insulating sheet portion 25F may correspond to the shape of the cutout 261F. The first insulating sheet portion 25F may be smaller in size than the cutout 261F. This makes it possible to reduce the disposal amount of the resin material.

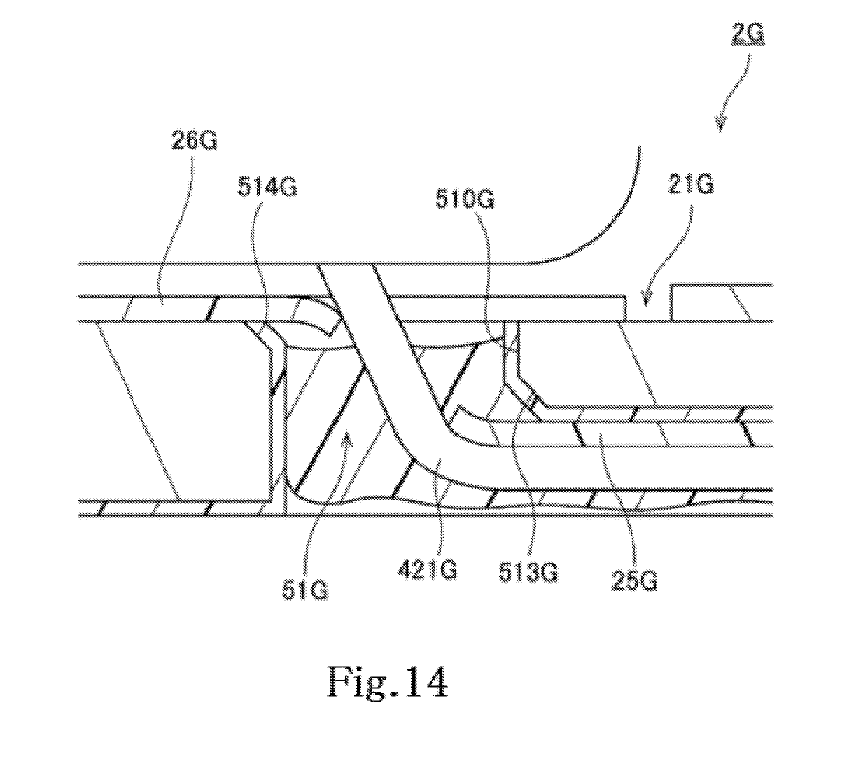

FIG. 14 is a partial vertical sectional view of a stationary unit 2G according to a yet another further modified example of a preferred embodiment of the present invention. The base member 21G shown in FIG. 14 preferably includes a lower chamfered surface 513G defined in the lower opening edge of the base through-hole 51G. When seen in a plan view, the lower chamfered surface 513G overlaps with a portion of the first insulating sheet portion 25G. The base member 21G shown in FIG. 14 further includes an upper chamfered surface 514G defined in the upper opening edge of the base through-hole 51G. When seen in a plan view, the upper chamfered surface 514G overlaps with a portion of the second insulating sheet portion 26G. This makes it possible to widen the flexible regions of the first insulating sheet portion 25G and the second insulating sheet portion 26G without having to enlarge the inner diameter of the base through-hole 51G as a whole. For that reason, the stresses acting on the lead wires 421G are reduced. When seen in a vertical cross section, the base member 21G may include curvilinear round surfaces in place of the lower chamfered surface 513G and the upper chamfered surface 514G.

If the lower chamfered surface 513G and the upper chamfered surface 514G are provided as shown in FIG. 14, the corner portions arranged in the upper and lower end portions of the tubular surface 510G defining the base through-hole 51G become gentle. Thus, the external forces acting on the lead wires 421G will be reduced. Accordingly, the protection films covering the lead wires 421G are further prevented from getting damaged.

In the second preferred embodiment and the respective modified examples of preferred embodiments of the present invention, the insulating portion is preferably provided between the first insulating sheet portion and the inner bottom portion. However, the present invention is not limited thereto. For example, the insulating portion may be omitted as long as contact between the lead wires and the base member can be prevented by the first insulating sheet portion.

Furthermore, the circuit substrate may extend to the lower surface of the ring-shaped wall portion. The land portions may be arranged in the portion of the circuit substrate positioned on the lower surface of the ring-shaped wall portion. The lead wires may be soldered to the land portions.

Moreover, the circuit substrate may not necessarily be a flexible printed substrate. The circuit substrate may be, e.g., a rigid substrate such as, for example, a connector or the like.

The spindle motor of the various preferred embodiments of the present invention can be applied to different kinds of disk drive apparatuses. The disk drive apparatus may be the one that rotates a disk other than the magnetic disk, e.g., an optical disk. According to preferred embodiments of the present invention, it is possible to make the disk drive apparatus thinner in the axial direction. Accordingly, preferred embodiments of the present invention are particularly useful in a spindle motor included in a disk drive apparatus for a thin notebook-type PC or a tablet-type PC.

In the aforementioned preferred embodiments, description has been made of a so-called shaft rotating type motor in which a sleeve belongs to a stationary unit with a shaft belonging to a rotary unit. However, the motor of preferred embodiments of the present invention may be a so-called shaft fixing type motor in which a shaft belongs to a stationary unit with a sleeve belonging to a rotary unit.

The specific shapes of the respective components may differ from those shown in the respective figures of the subject application. The respective components of the preferred embodiments and the modified examples described above may be appropriately combined unless a conflict arises.

The preferred embodiments of present invention and the modifications thereof can find applications in a spindle motor and a disk drive apparatus.

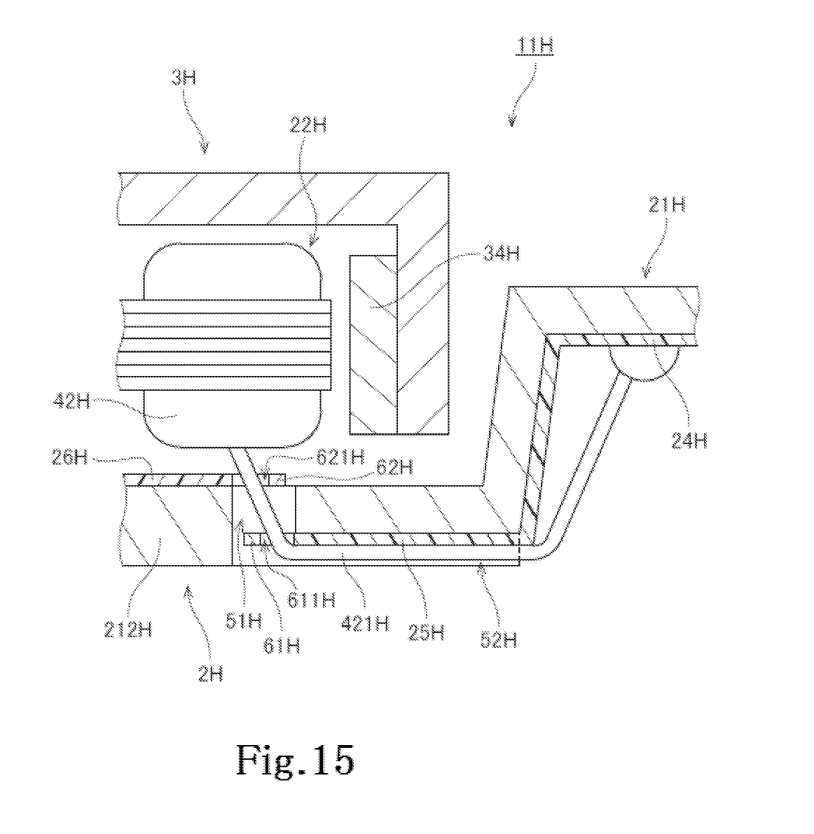

FIG. 15 is a partial vertical sectional view of a spindle motor 11H according to a third preferred embodiment of the present invention. As shown in FIG. 15, the spindle motor 11H preferably includes a stationary unit 2H and a rotary unit 3H.

The stationary unit 2H preferably includes a base member 21H, an armature 22H, and a circuit substrate 24H. The base member 21H is preferably made of metal. The base member 21H may be made of a material such as, e.g., an aluminum alloy, a ferromagnetic or non-magnetic stainless steel, a magnesium alloy, etc. The armature 22H preferably includes a plurality of coils 42H. The armature 22H is positioned above the base member 21H. The circuit substrate 24H is arranged on the lower surface of the base member 21H.

The spindle motor 11H preferably includes a plurality of lead wires 421H which interconnect the coils 42H and the circuit substrate 24H. Only one of the lead wires 421H is shown in FIG. 15. Each lead wire 421H is electrically connected to both the coils 42H and the circuit substrate 24H.

The rotary unit 3H is supported to rotate about a center axis extending up and down. The rotary unit 3H preferably includes a magnet 34H. The armature 22H and the magnet 34H are opposed to each other through a gap. During the operation of the spindle motor 11H, torque is generated by the magnetic flux generated between the armature 22H and the magnet 34H.

As shown in FIG. 15, the base member 21H preferably includes a bottom portion 212H, a base through-hole 51H, and a base groove portion 52H. The bottom portion 212H is positioned below the armature 22H and extends in a ring shape. The base through-hole 51H axially extends through the bottom portion 212H. The base groove portion 52H is preferably arranged on the lower surface of the base member 21H. The base groove portion 52H extends radially outward from the lower end portion of the base through-hole 51H.

A first insulating sheet portion 25H is arranged on the bottom surface of the base groove portion 52H. In the example shown in FIG. 15, a portion of the circuit substrate 24H defines the first insulating sheet portion 25H. Alternatively, the first insulating sheet portion 25H may be a member provided independently of the circuit substrate 24H, if so desired. The first insulating sheet portion 25H preferably includes a first overhang portion 61H at the radial inner end thereof. When seen in a plan view, the first overhang portion 61H overlaps with the lower opening of the base through-hole 51H. The first overhang portion 61H preferably includes holes 611H through which the lead wires 421H pass.

A second insulating sheet portion 26H is arranged on the upper surface of the bottom portion 212H. The second insulating sheet portion 26H preferably includes a second overhang portion 62H. When seen in a plan view, the second overhang portion 62H overlaps with the upper opening of the base through-hole 51H. The second overhang portion 62H preferably includes holes 621H through which the lead wires 421H pass.

As shown in FIG. 15, the lead wires 421H extending from the coils 42H are led out toward the lower surface of the bottom portion 212H through the holes 621H of the second overhang portion 62H, the upper opening of the base through-hole 51H, the lower opening of the base through-hole 51H and the holes 611H of the first overhang portion 61H. The respective lead wires 421H extend to the circuit substrate 24H through the base groove portion 52H. The tip ends of the respective lead wires 421H are connected to the circuit substrate 24H.

In the spindle motor 11H, as mentioned above, the lead wires 421H pass through the single base through-hole 51H. Thus, as compared with a case where the lead wires 421H pass through different base through-holes respectively, it is possible to use just the base through-hole 51H rather than a plurality of base through-holes. As a result of this structure, it is possible to minimize or prevent a reduction in the rigidity of the base member 21H. The lead wires 421H are led out toward the lower surface of the base member 21H through the individual holes 621H of the second overhang portion 62H and the individual holes 611H of the first overhang portion 61H. This makes it possible to easily distinguish the led-out lead wires 421H from one another.

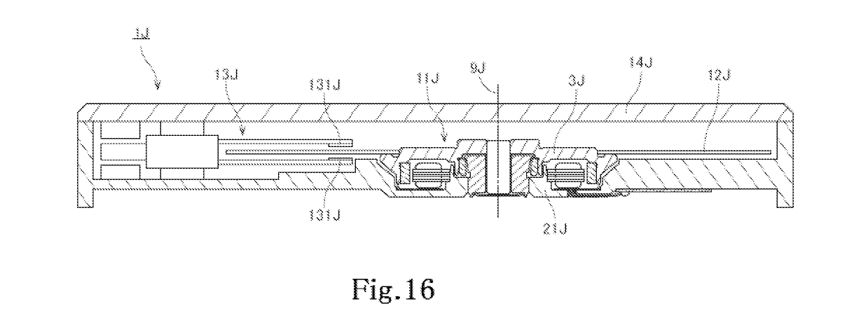

FIG. 16 is a vertical sectional view of a disk drive apparatus 1J according to a fourth preferred embodiment of the present invention. The disk drive apparatus 1J is preferably an apparatus arranged to rotate, e.g., a magnetic disk 12J, and performing information reading and writing tasks with respect to the magnetic disk 12J. As shown in FIG. 16, the disk drive apparatus 1J preferably includes a spindle motor 11J, a magnetic disk 12J, an access unit 13J, and a cover 14J.

The spindle motor 11J supports the magnetic disk 12J and rotates the magnetic disk 12J about a center axis 9J. The spindle motor 11J includes a base member 21J extending in a direction perpendicular or substantially perpendicular to the center axis 9J. The upper region of the base member 21J is covered with the cover 14J. A rotary unit 3J of the spindle motor 11J, the magnetic disk 12J, and the access unit 13J are accommodated within a housing defined by the base member 21J and the cover 14J. The access unit 13J is arranged to move a head 131J along the recording surface of the magnetic disk 12J and to perform information reading and writing tasks with respect to the magnetic disk 12J.

The disk drive apparatus 1J may alternatively include two or more magnetic disks 12J. Furthermore, the access unit 13J may perform only one of the information reading and writing tasks with respect to the magnetic disk 12J.

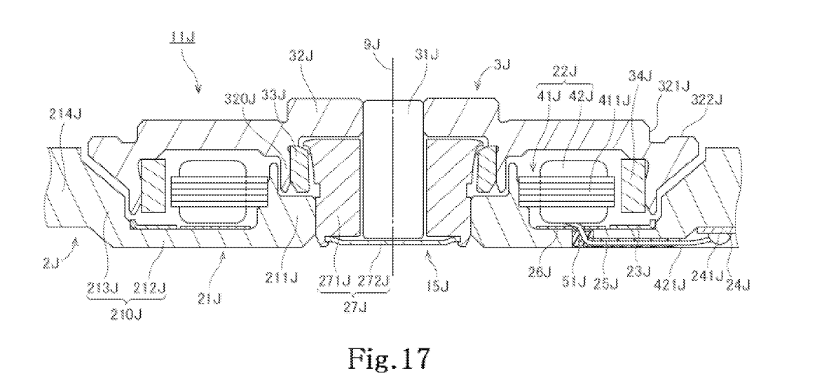

Next, the detailed configuration of the spindle motor 11J will be described. FIG. 17 is a vertical sectional view of the spindle motor 11J. As shown in FIG. 17, the spindle motor 11J includes a stationary unit 2J and the rotary unit 3J. The stationary unit 2J is kept stationary with respect to the base member 21J and the cover 14J. The rotary unit 3J is supported to rotate with respect to the stationary unit 2J.

The stationary unit 2J of the present preferred embodiment preferably includes a base member 21J, an armature 22J, a thrust yoke 23J, a circuit substrate 24J, a first insulating sheet portion 25J, a second insulating sheet portion 26J, and a stationary bearing unit 27J.

The base member 21J is arranged below the rotary unit 3J, the magnetic disk 12J and the access unit 13J to extend in a direction perpendicular or substantially perpendicular to the center axis 9J. The base member 21J can be obtained by casting metal such as, e.g., aluminum alloy. Alternatively, the base member 21J may be obtained by other methods such as, for example, cutting, pressing, etc. In addition, the base member 21J may be defined by a plurality of members.

The base member 21J preferably includes a cylinder portion 211J, an inner bottom portion 212J, a ring-shaped wall portion 213J, and an outer bottom portion 214J. The inner bottom portion 212J is arranged below the armature 22J to extend in a ring shape. Moreover, the inner bottom portion 212J is positioned more downward than the outer bottom portion 214J. The cylinder portion 211J extends upward in a cylindrical or substantially cylindrical shape from the radial inner edge of the inner bottom portion 212J. The ring-shaped wall portion 213J extends radially outward and upward from the radial outer edge of the inner bottom portion 212J. The outer bottom portion 214J extends further radially outward from the radial outer edge of the ring-shaped wall portion 213J.

The armature 22J, the thrust yoke 23J, the second insulating sheet portion 26J, and a portion of the rotary unit 3J are preferably accommodated at the upper side of the inner bottom portion 212J and at the radial inner side of the ring-shaped wall portion 213J. Thus, the outer bottom portion 214J is arranged at the same height or substantially at the same height as the armature 22J and a portion of the rotary unit 3J. The circuit substrate 24J is arranged radially outward of the inner bottom portion 212J and the ring-shaped wall portion 213J. For that reason, the armature 22J and the circuit substrate 24J preferably do not axially overlap with each other. Accordingly, the circuit substrate 24J can be arranged higher than the bottom surface of the inner bottom portion 212J. This makes it possible to reduce the axial thickness of the spindle motor 11J as a whole.

The armature 22J preferably includes a stator core 41J and a plurality of coils 42J. The stator core 41J and the coils 42J are positioned above the inner bottom portion 212J. The stator core 41J is preferably defined by a steel plate laminate obtained by axially stacking electromagnetic steel plates, e.g., silicon steel plates, one above another. The stator core 41J is fixed to the outer circumferential surface of the cylinder portion 211J. Moreover, the stator core 41J preferably includes a plurality of teeth 411J extending radially outward. The teeth 411J are preferably arranged at a regular or substantially regular interval in the circumferential direction.

The coils 42J are preferably defined by, for example, lead wires wound around the respective teeth 411J. More specifically, the coils 42J of the present preferred embodiment are preferably defined by three lead wires 421J arranged to supply three-phase currents therethrough. The end portions of the respective lead wires 421J are led out toward the lower surface of the base member 21J via a base through-hole 51J defined in the inner bottom portion 212J.

The thrust yoke 23J is preferably a ring-shaped member arranged on the upper surface of the inner bottom portion 212J. The thrust yoke 23J is preferably made of a magnetic material such as, e.g., an electromagnetic steel plate (e.g., a silicon steel plate), a ferromagnetic stainless steel plate (e.g., SUS430), a cold-rolled steel plate (e.g., SPCC or SPCE), etc. The thrust yoke 23J is preferably positioned below the magnet 34J to be described later. A magnetic attraction force is generated between the thrust yoke 23J and the magnet 34J. Thus, the rotary unit 3J is attracted toward the stationary unit 2J.

The circuit substrate 24J is preferably arranged on the lower surface of the outer bottom portion 214J. Three land portions 241J including exposed copper foils are preferably arranged on the lower surface of the circuit substrate 24J. The three lead wires 421J led out from the base through-hole 51J are respectively soldered to respective ones of the three land portions 241J. Thus, the circuit substrate 24J and the coils 42J are electrically connected to each other. An electric current which drives the spindle motor 11J is supplied from an external power source to the coils 42J through the circuit substrate 24J.

The number of the lead wires 421J led out from the base through-hole 51J is not limited to three. For example, four lead wires may be led out from the base through-hole 51J if so desired. Likewise, the number of the base through-hole 51J is not limited to one but may be two or more. One lead wire or a plurality of lead wires may be led out from one base through-hole.

A flexible printed substrate having flexibility is preferably used as the circuit substrate 24J of the present preferred embodiment. Use of the flexible printed substrate makes it possible to arrange the circuit substrate 24J along the irregularities of the lower surface of the base member 21J. Use of the flexible printed substrate also makes it possible to reduce the axial thickness of the circuit substrate 24J as compared with other substrates. Accordingly, it is possible to further reduce the axial thickness of the spindle motor 11J.

The stationary bearing unit 27J preferably includes a sleeve 271J and a cap 272J. The sleeve 271J is arranged around the below-mentioned shaft 31J to axially extend in a cylindrical or substantially cylindrical shape. The lower portion of the sleeve 271J is accommodated radially inward of the cylinder portion 211J of the base member 21J and is preferably fixed to the cylinder portion 211J by, e.g., an adhesive agent. The inner circumferential surface of the sleeve 271J is radially opposed to the outer circumferential surface of the shaft 31J. The cap 272J closes the lower opening of the sleeve 271J. The sleeve 271J may alternatively be defined by a plurality of members, for example.

The rotary unit 3J of the present preferred embodiment preferably includes a shaft 31J, a hub 32J, a ring-shaped member 33J, and a magnet 34J.

The shaft 31J is arranged radially inward of the sleeve 271J to extend in the axial direction. The shaft 31J is preferably made of metal such as, e.g., ferromagnetic or non-magnetic stainless steel. The upper end portion of the shaft 31J preferably protrudes farther upward than the upper surface of the sleeve 271J.

The hub 32J extends radially outward from the peripheral edge of the upper end portion of the shaft 31J. The inner circumferential portion of the hub 32J is fixed to the upper end portion of the shaft 31J. As shown in FIG. 17, the hub 32J of the present preferred embodiment preferably includes a ring-shaped projection 320J protruding downward. The ring-shaped member 33J is fixed to the inner circumferential surface of the ring-shaped projection 320J. The inner circumferential surface of the ring-shaped member 33J is radially opposed to the outer circumferential surface of the sleeve 271J.

The hub 32J preferably includes a first holding surface 321J having a cylindrical or substantially cylindrical shape and a second holding surface 322J extending radially outward from the lower end portion of the first holding surface 321J. The inner circumferential portion of the magnetic disk 12J makes contact with at least a portion of the first holding surface 321J. Furthermore, the lower surface of the magnetic disk 12J makes contact with at least a portion of the second holding surface 322J. Thus, the magnetic disk 12J is held in place.

A lubricant is preferably provided between the shaft 31J and the stationary bearing unit 27J, between the hub 32J and the stationary bearing unit 27J, and between the ring-shaped member 33J and the stationary bearing unit 27J. The liquid level of the lubricant is preferably positioned between the sleeve 271J and the ring-shaped member 33J. For example, polyol ester-based oil or diester-based oil is preferably used as the lubricant. The shaft 31J is rotatably supported with respect to the stationary bearing unit 27J through the lubricant.

That is to say, in the present preferred embodiment, a bearing mechanism 15J preferably is defined by: the sleeve 271J and the cap 272J, which are members belonging to the stationary unit 2J; the shaft 31J, the hub 32J, and the ring-shaped member 33J, which are members belonging to the rotary unit 3J; and the lubricant which is provided between these members. The bearing mechanism 15J is accommodated within the cylinder portion 211J. The rotary unit 3J is supported on the bearing mechanism 15J and is rotated about the center axis 9J.

The magnet 34J is preferably arranged radially outward of the armature 22J and is fixed to the hub 32J. The magnet 34J of the present preferred embodiment preferably has an annular or substantially annular shape. The inner circumferential surface of the magnet 34J is radially opposed to the radial outer end surfaces of the teeth 411J. The inner circumferential surface of the magnet 34J is alternately magnetized with N-poles and S-poles along the circumferential direction.

A plurality of magnets may be used in place of the annular magnet 34J. In case of using a plurality of magnets, they may be arranged along the circumferential direction so that N-poles and S-poles can be alternately lined up.

In the spindle motor 11J described above, if a drive current is supplied to the coils 42J via the circuit substrate 24J, magnetic fluxes are generated in the teeth 411J. Then, circumferential torque is generated by the magnetic flux acting between the teeth 411J and the magnet 34J. As a result, the rotary unit 3J is rotated about the center axis 9J with respect to the stationary unit 2J. The magnetic disk 12J supported on the hub 32J is rotated about the center axis 9J together with the rotary unit 3J.

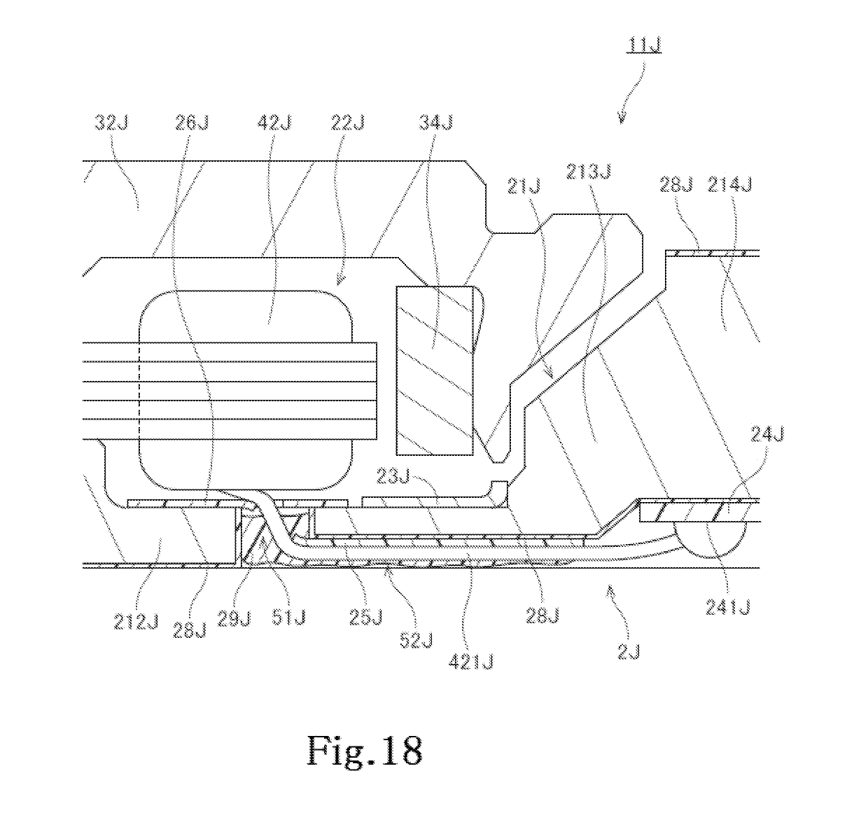

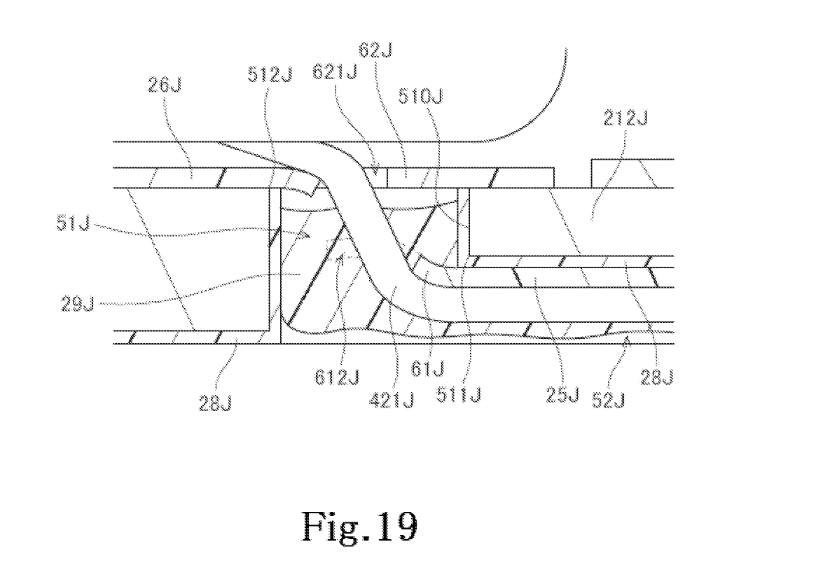

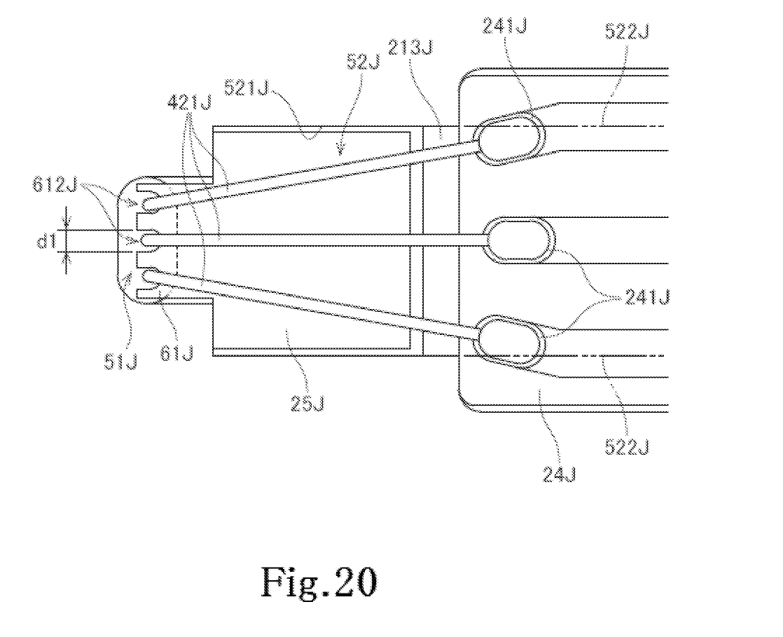

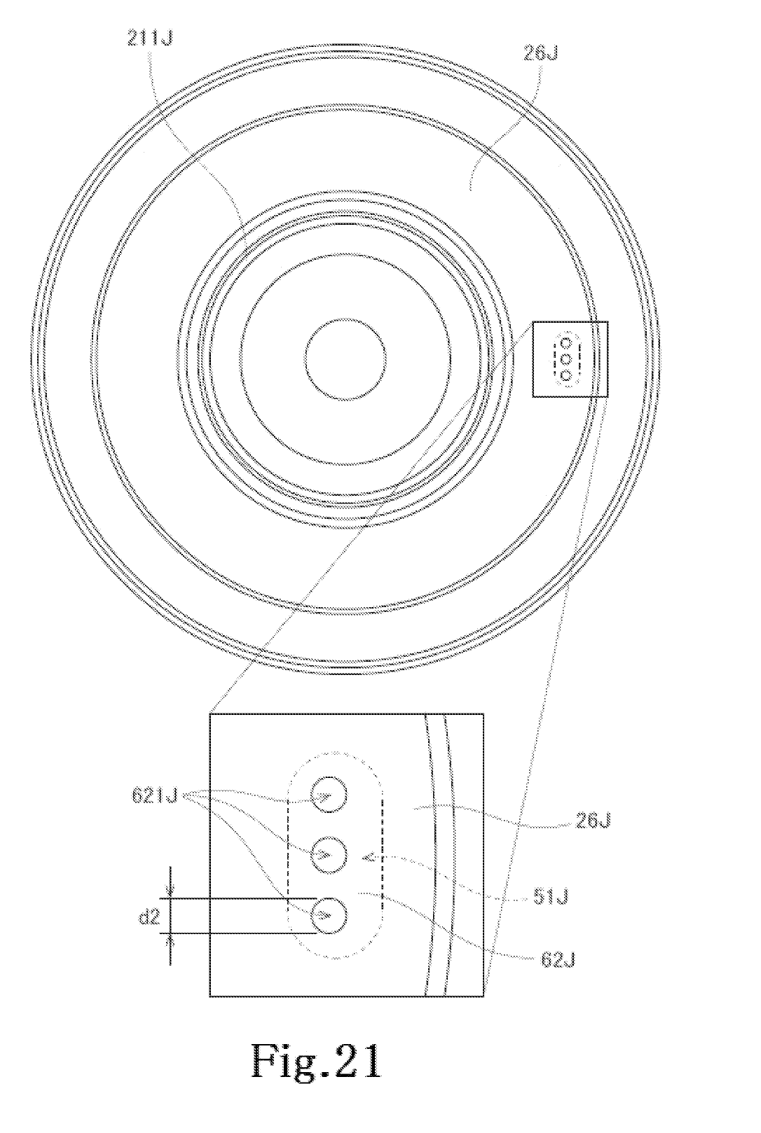

Next, description will be made on the routes of the lead wires 421J extending from the coils 42J to the land portions 241J. FIG. 18 is a partial vertical sectional view of the spindle motor 11J, which includes each of the routes of the lead wires 421J extending from the coils 42J to the land portions 241J. FIG. 19 is a vertical sectional view showing a portion of each of the routes of the lead wires 421J on an enlarged scale. FIG. 20 is a partial bottom view of the base member 21J, which includes the routes of the lead wires 421J. FIG. 21 is a partial plan view of the base member 21J. In FIG. 20, an adhesive agent 29J is omitted from the illustration for the sake of clarity. In FIG. 21, the adhesive agent 29J and the lead wires 421J are omitted from the illustration for the sake of clarity. In the following description, reference will be made to FIG. 17 and, if appropriate, FIGS. 18 through 21.

At least a portion of the surface of the base member 21J is preferably covered with an insulating portion 28J. The insulating portion 28J is preferably formed by electro-coating, e.g., a resin as an insulating material. Alternatively, the insulating portion 28J may be formed by powder coating. At least a portion of the surface of the base member 21J may be covered with a metal plating layer in place of the insulating portion 28J. In the present preferred embodiment, as shown in FIG. 18, at least the lower surface of the inner bottom portion 212J, the lower surface of the ring-shaped wall portion 213J, the lower surface of the outer bottom portion 214J, and the upper surface of the outer bottom portion 214J are covered with the insulating portion 28J.

The base member 21J preferably includes a base through-hole 51J. The base through-hole 51J is arranged below the armature 22J to axially extend through the inner bottom portion 212J. As shown in FIG. 19, a tubular surface 510J of the base member 21J defining the base through-hole 51J is preferably covered with the insulating portion 28J. Furthermore, a base groove portion 52J extending in the radial direction is preferably defined on the lower surfaces of the inner bottom portion 212J and the ring-shaped wall portion 213J. As shown in FIG. 18, the base groove portion 52J preferably extends radially outward from the lower end portion of the base through-hole 51J toward the circuit substrate 24J. In other words, the lower end portion of the base through-hole 51J is opened into the base groove portion 52J. The bottom surface and the wall surfaces defining the base groove portion 52J are preferably covered with the insulating portion 28J.

A first insulating sheet portion 25J is preferably arranged within the base groove portion 52J. The first insulating sheet portion 25J of the present preferred embodiment is preferably a member provided independently of the circuit substrate 24J. The first insulating sheet portion 25J is fixed to the bottom surface of the base groove portion 52J preferably by an adhesive agent or a sticky material, for example. In addition, a second insulating sheet portion 26J is arranged on the upper surface of the inner bottom portion 212J. The second insulating sheet portion 26J is preferably fixed to the upper surface of the inner bottom portion 212J by an adhesive agent or a sticky material, for example.

The first insulating sheet portion 25J and the second insulating sheet portion 26J are preferably made of an insulating material, e.g., a resin such as, for example, polyethylene terephthalate (PET) or the like. The thickness of the first insulating sheet portion 25J and the second insulating sheet portion 26J is preferably larger than the thickness of the insulating portion 28J and is smaller than the thickness of the circuit substrate 24J at the land portions 241J. At least a portion of the surface of the base member 21J may be covered with a metal plating layer in place of the insulating portion 28J. In this case, the thickness of the first insulating sheet portion 25J and the second insulating sheet portion 26J is preferably larger than the thickness of the metal plating layer.

The second insulating sheet portion 26J is interposed between the inner bottom portion 212J and the coils 42J. This prevents the base member 21J and the coils 42J from making contact with each other. Thus, the base member 21J and the coils 42J are electrically insulated from each other. The interposition of the second insulating sheet portion 26J makes it possible to bring the inner bottom portion 212J and the coils 42J into close proximity with each other in the axial direction. This further reduces the axial thickness of the spindle motor 11J.

As shown in FIGS. 19 and 20, the first insulating sheet portion 25J preferably includes a first overhang portion 61J extending toward a lower side of the base through-hole 51J. When seen in a plan view, the first overhang portion 61J overlaps with the lower opening of the base through-hole 51J. The first overhang portion 61J preferably includes three cutouts 612J through which the lead wires 421J pass. The width d1 of each of the cutouts 612J is larger than the diameter of the lead wires 421J. Each of the three lead wires 421J is led out from the base through-hole 51J into the base groove portion 52J through each of the three cutouts 612J. That is to say, the three lead wires 421J pass through the respective cutouts 612J.

As shown in FIGS. 19 and 21, the second insulating sheet portion 26J preferably includes a second overhang portion 62J extending toward an upper side of the base through-hole 51J. When seen in a plan view, the second overhang portion 62J overlaps with the upper opening of the base through-hole 51J. The second overhang portion 62J preferably includes three holes 621J through which the lead wires 421J pass. The diameter d2 of each of the three holes 621J is larger than the diameter of the lead wires 421J. Each of the three lead wires 421J is led out from the upper side of the inner bottom portion 212J into the base through-hole 51J through each of the three holes 621J. That is to say, the three lead wires 421J pass through the respective holes 621J.

Each of the lead wires 421J led out from the coils 42J preferably include a bare conductor and a protection film (not shown) covering the bare conductor, which is made of an insulating material. The diameter of each of the lead wires 421J mentioned above denotes the diameter of a cross section including both the bare conductor of each of the lead wires 421J and the protection film covering the bare conductor. Similarly, the diameter of lead wires to be described later denotes the diameter of a cross section including both a bare conductor and a protection film covering the bare conductor.

As shown in FIGS. 18 and 19, the lead wires 421J extend toward the base through-hole 51J from positions defined at the upper side of the inner bottom portion 212J and at the radial inner side of the center of the base through-hole 51J. The lead wires 421J are led out into the base groove portion 52J through the holes 621J of the second overhang portion 62J, the upper opening of the base through-hole 51J, the lower opening of the base through-hole 51J, and the cutouts 612J of the first overhang portion 61J. Within the base groove portion 52J, the lead wires 421J extend radially outward along the lower surface of the first insulating sheet portion 25J. At the radial outer side of the inner bottom portion 212J, the end portions of the lead wires 421J are soldered to the land portions 241J of the circuit substrate 24J.

In the spindle motor 11J described above, the three lead wires 421J extend through one base through-hole 51J. Therefore, as compared with a case where three base through-holes through which the three lead wires 421J pass respectively are provided, it is possible to reduce the number of the base through-hole 51J. Since the number of the base through-hole 51J is just one, it is possible to reduce the width of the base groove portion 52J connected to the base through-hole 51J. Accordingly, it becomes possible to minimize or prevent a reduction in the rigidity of the base member 21J.

The three lead wires 421J are led out toward the lower surface of the base member 21J through the respective holes 621J of the second overhang portion 62J and the respective ones of the cutouts 612J of the first overhang portion 61J. This makes it possible to easily distinguish the three lead wires 421J led out toward the lower surface of the base member 21J from each other. Accordingly, during the manufacture of the spindle motor 11J, the three lead wires 421J can be respectively connected to the three land portions 241J without mistake.

Particularly, in the present preferred embodiment, the first overhang portion 61J preferably includes the three cutouts 612J arranged to pass the lead wires 421J therethrough and the second overhang portion 62J includes the three holes 621J arranged to pass the lead wires 421J therethrough. That is to say, in the present preferred embodiment, the first overhang portion 61J and the second overhang portion 62J are shaped to pass the lead wires 421J therethrough. Since the respective lead wires 421J extend through the three cutouts 612J and the three holes 621J, it is possible to prevent the three lead wires 421J from being erroneously connected to the land portions other than the intended land portions.

In the present preferred embodiment, as shown in FIG. 19, preferably at least a portion of each cutout 612J of the first overhang portion 61J axially overlaps with at least a portion of the holes 621J of the second overhang portion 62J. If the cutouts 612J of the first overhang portion 61J arranged to pass the lead wires 421J therethrough and the holes 621J of the second overhang portion 62J arranged to pass the lead wires 421J therethrough are arranged to axially overlap with each other, the first overhang portion 61J and the second overhang portion 62J do not completely block the route for the passage of the lead wires 421J when seen in the axial direction. Accordingly, it is possible to easily pass the lead wires 421J through the base through-hole 51J.

In the present preferred embodiment, the lead wires 421J preferably make contact with the second overhang portion 62J or the first overhang portion 61J when passing through the base through-hole 51J. The insulating material defining the first insulating sheet portion 25J and the second insulating sheet portion 26J is interposed between the inner bottom portion 212J and the lead wires 421J. This prevents direct contact of the base member 21J and the lead wires 421J. Thus, the lead wires 421J are prevented from becoming damaged or broken and the base member 21J and the lead wires 421J are electrically insulated from each other.

In the present preferred embodiment, as shown in FIG. 19, the first insulating sheet portion 25J is interposed between a radial outer lower corner portion 511J of the tubular surface 510J defining the base through-hole 51J and each of the lead wires 421J. For that reason, each of the lead wires 421J does not make contact with the lower corner portion 511J or the insulating portion 28J covering the lower corner portion 511J. Moreover, the second insulating sheet portion 26J is preferably interposed between a radial inner upper corner portion 512J of the tubular surface 510J defining the base through-hole 51J and each of the lead wires 421J. For that reason, each of the lead wires 421J do not make contact with the upper corner portion 512J or the insulating portion 28J covering the upper corner portion 512J. Thus, stresses are preferably prevented from concentrating on the lead wires 421J. As a result, the lead wires 421J are prevented from becoming damaged.

The protection film of each of the lead wires 421J is easily damaged when it makes contact with a rigid material such as metal or the like. In the present preferred embodiment, the lead wires 421J make contact with the first insulating sheet portion 25J and the second insulating sheet portion 26J which are lower in rigidity than the metal of which the base member 21J is made. Thus, the protection film is prevented from becoming damaged. Even if the protection film of each of the lead wires 421J is damaged, there preferably is no possibility that the lead wires 421J and the base member 21J make contact with each other. In particular, the first insulating sheet portion 25J and the second insulating sheet portion 26J are preferably made of an insulating material. This prevents electric conduction between the lead wires 421J and the base member 21J.

In the present preferred embodiment, the first overhang portion 61J is positioned radially inward of the radial outer lower corner portion 511J of the tubular surface 510J. The first overhang portion 61J is bent upward at the radial inner side of the lower corner portion 511J while making contact with the lead wires 421J. This reduces the force generated between the first insulating sheet portion 25J and the lead wires 421J. As a result, the lead wires 421J are further prevented from becoming damaged.

Similarly, the second overhang portion 62J is preferably positioned radially outward of the radial inner upper corner portion 512J of the tubular surface 510J. The second overhang portion 62J is bent downward at the radial outer side of the upper corner portion 512J while making contact with the lead wires 421J. This reduces the force generated between the second insulating sheet portion 26J and the lead wires 421J. As a result, the lead wires 421J are further prevented from becoming damaged.

In the present preferred embodiment, the lead wires 421J extend from the coils 42J to the land portions 241J with little slackness. In other words, tension is exerted on each of the lead wires 421J. This prevents the lead wires 421J from protruding downward from the base groove portion 52J. However, if tension is exerted on the lead wires 421J, the protection films covering the surfaces of the lead wires 421J get damaged with ease. In the present preferred embodiment, however, the external forces applied to the lead wires 421J are reduced by the first insulating sheet portion 25J and the second insulating sheet portion 26J. As a result, the lead wires 421J are prevented from being damaged.

In the present preferred embodiment, the first insulating sheet portion 25J and the circuit substrate 24J are preferably provided by different members. The radial outer end portion of the first insulating sheet portion 25J is positioned radially inward of the radial inner end portion of the circuit substrate 24J. The lower surface of the ring-shaped wall portion 213J is positioned between the radial outer end portion of the first insulating sheet portion 25J and the radial inner end portion of the circuit substrate 24J. That is to say, in the present preferred embodiment, the first insulating sheet portion 25J is not arranged on the lower surface of the ring-shaped wall portion 213J as a slant surface or a step surface. This preferably makes it possible to prevent the first insulating sheet portion 25J from being separated downward from the base member 21J.

In the present preferred embodiment, as shown in FIGS. 18 through 20, the radial inner end portion of the first insulating sheet portion 25J is positioned radially outward of the radial inner end portion of the tubular surface 510J defining the base through-hole 51J. Furthermore, the axial thickness of the base member 21J at the radial inner side of the base through-hole 51J is larger than the axial thickness of the base member 21J in the base groove portion 52J. This increases the rigidity of the base member 21J at the radial inner side of the base through-hole 51J.

In the present preferred embodiment, as shown in FIG. 20, three lead wires 421J extend radially or substantially radially from the lower end portion of the base through-hole 51J. The circumferential width of each of the base groove portion 52J and the first insulating sheet portion 25J is preferably widened radially outward in a stepwise fashion. This prevents the lead wires 421J and the wall surfaces 521J of the base groove portion 52J from making contact with each other, while reducing the breadth of the base groove portion 52J. In the present preferred embodiment, as shown in FIG. 20, a portion of the wall surfaces 521J of the base groove portion 52J makes contact with the first insulating sheet portion 25J in the radial direction. Thus, the first insulating sheet portion 25J is radially positioned in place.

Referring to FIG. 20, a pair of imaginary lines 522J extending radially outward from the opposite wall surfaces 521J of the radial outer end portion of the base groove portion 52J is indicated by double-dot chain lines. In the present preferred embodiment, the centers of the respective land portions 241J are positioned between the imaginary lines 522J. This makes it possible to prevent the lead wires 421J extending toward the respective land portions 241J from making contact with the wall surfaces 521J of the base groove portion 52J.

As shown in FIG. 20, each of the land portions 241J of the present preferred embodiment preferably has an elliptical or substantially elliptical shape having a major axis and a minor axis when seen in a plan view. The major axes of the respective land portions 241J are arranged to extend along the radial or substantially radial lines diverging from the base through-hole 51J. This makes it possible to prolong the length of the lead wires 421J overlapping with the respective land portions 241J. For that reason, it becomes easy to solder the lead wires 421J to the respective land portions 241J.

As shown in FIGS. 18 and 19, the stationary unit 2J of the present preferred embodiment preferably further includes, for example, an adhesive agent 29J as a sealing material. The base through-hole 51J is sealed by the adhesive agent 29J. This preferably prevents gasses from flowing through the base through-hole 51J. As a result, it is possible to enhance the air-tightness of the disk drive apparatus 1J. In addition, the lead wires 421J are fixed by the adhesive agent 29J. As a consequence, the lead wires 421J are prevented from protruding farther downward than the lower surface of the inner bottom portion 212J.

In the present preferred embodiment, the adhesive agent 29J is preferably arranged not only within the base through-hole 51J but also within the base groove portion 52J. This makes it possible to fix the lead wires 421J by the adhesive agent 29J over a broader range. For that reason, the lead wires 421J are prevented from protruding farther downward than the lower surface of the inner bottom portion 212J.

In the present preferred embodiment, the axial depth of the base groove portion 52J is larger than the sum of the thickness of the insulating portion 28J, the thickness of the first insulating sheet portion 25J, the diameter of the lead wire 421J, and the thickness of the adhesive agent 29J. Thus, the adhesive agent 29J is preferably prevented from extruding downward from the base groove portion 52J.

Other sealing materials may be used in place of the adhesive agent 29J, if so desired. For example, a resin material other than the adhesive agent may be used as a sealing material.

While illustrative preferred embodiments of the present invention have been described above, the present invention is not limited to the aforementioned preferred embodiments.

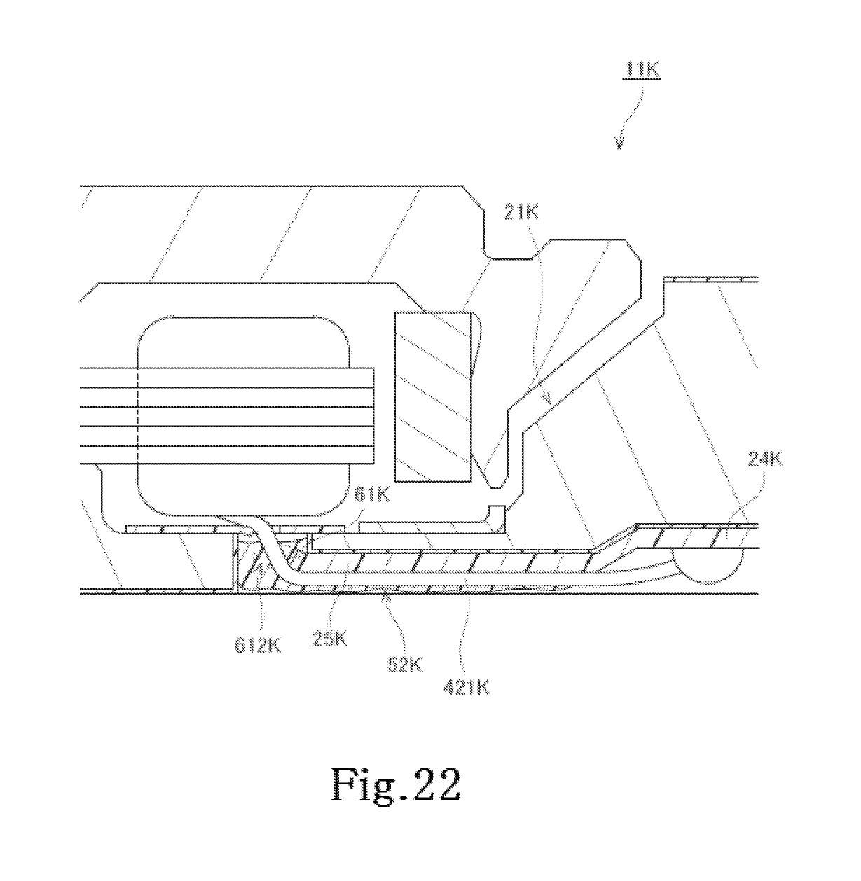

FIG. 22 is a partial vertical sectional view of a spindle motor 11K according to one modified example of a preferred embodiment of the present invention. In the example shown in FIG. 22, a portion of the circuit substrate 24K extends into the base groove portion 52K so as to define a first insulating sheet portion 25K. The circuit substrate 24K preferably includes a first overhang portion 61K arranged at the radial inner end thereof. In the example shown in FIG. 22, the first overhang portion 61K preferably includes cutouts 612K. The lead wires 421K extend through the cutouts 612K. In this way, the first insulating sheet portion 25K may be realized by using a portion of the circuit substrate 24K including an insulating material. This makes it possible to handle the first insulating sheet portion 25K and the circuit substrate 24K together as a single monolithic member. For that reason, it is possible to reduce the number of steps required in attaching the circuit substrate 24K and the first insulating sheet portion 25K to the base member 21K.

In case where a portion of the circuit substrate 24K is used as the first insulating sheet portion 25K, the axial thickness of the first insulating sheet portion 25K may be set smaller than the axial thickness of the remaining portion of the circuit substrate 24K. For example, if the circuit substrate 24K is defined by a plurality of axially-stacked thin films, one or some of the thin films may be made to extend toward the base groove portion 52K to define the first insulating sheet portion 25K. In this case, as compared with a case where the first insulating sheet portion 25K is defined by all the thin films of the circuit substrate 24K, it is possible to reduce the axial thickness of the first insulating sheet portion 25K. Accordingly, it is possible to reduce the axial depth of the base groove portion 52K, thus increasing the rigidity of the base member 21K.

More specifically, two layers, e.g., a sticky material layer and a polyimide layer, of the thin films defining the circuit substrate 24K may preferably be arranged to extend toward the base groove portion 52K and may be used as the first insulating sheet portion 25K. By doing so, it is possible to define the first insulating sheet portion 25K with a minimum number of layers. This makes it possible to reduce the axial thickness of the first insulating sheet portion 25K.

However, if the first insulating sheet portion 25J and the circuit substrate 24J are provided by different members as in the fourth preferred embodiment, it is possible to freely select the material of the first insulating sheet portion 25J. That is to say, the material of the first insulating sheet portion 25J is not limited to the material included in the circuit substrate 24J. For that reason, a suitable material can be used as the first insulating sheet portion 25K. In this respect, it is preferred that the first insulating sheet portion 25J and the circuit substrate 24J are provided by different members.

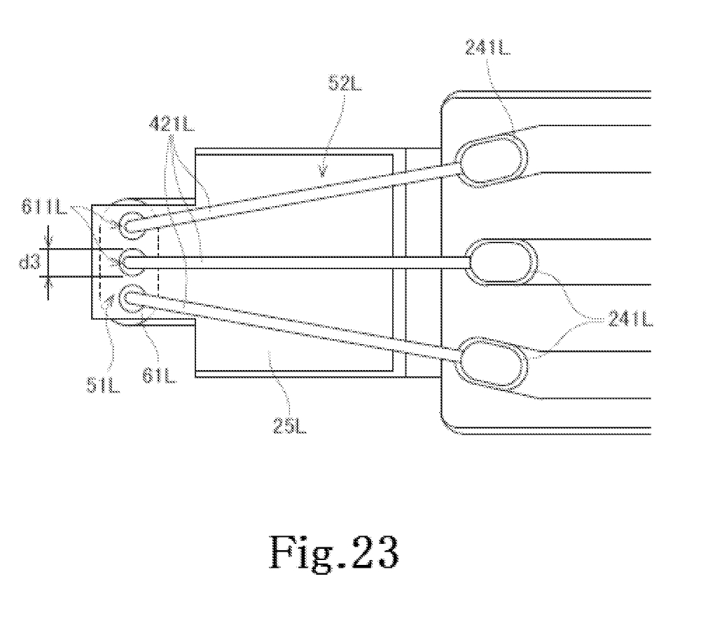

FIG. 23 is a partial bottom view of a base member according to another modified example of a preferred embodiment of the present invention. In the example shown in FIG. 23, three holes 611L are preferably defined in the first overhang portion 61L of the first insulating sheet portion 25L. The diameter d3 of the three holes 611L is larger than the diameter of the lead wires 421L. The three lead wires 421L are led out from the base through-hole 51L into the base groove portion 52L through the respective holes 611L. This preferably makes it possible to easily distinguish the three lead wires 421L led out toward the lower surface of the base member from each other. Accordingly, during the manufacture of the spindle motor, the three lead wires 421L can be respectively connected to the three land portions 241L without mistake.

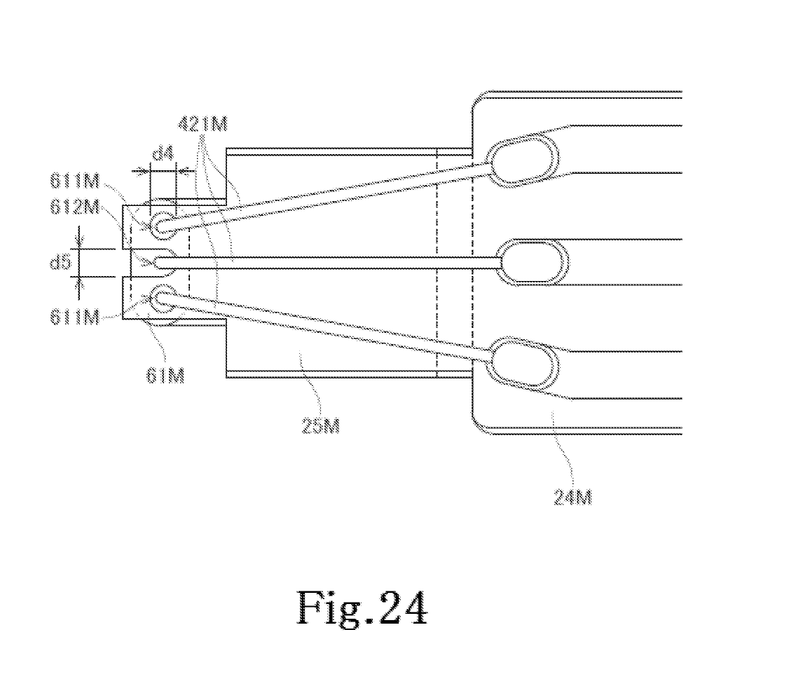

FIG. 24 is a partial bottom view of a base member according to a further modified example of a preferred embodiment of the present invention. In the example shown in FIG. 24, a portion of the circuit substrate 24M defines a first insulating sheet portion 25M. The first overhang portion 61M of the first insulating sheet portion 25M preferably includes a pair of holes 611M and a single cutout 612M. The holes 611M are arranged at peripheral sides. The cutout 612M is positioned between the holes 611M. The diameter d4 of each of the holes 611M and the width d5 of the cutout 612M are larger than the diameter of the lead wires 421M.

The three lead wires 421M extend through the holes 611M and the cutout 612M, respectively. The three lead wires 421M make contact with the first overhang portion 61M and extend into the base groove portion 52M. By doing so, it is possible to reliably position the two outer lead wires 421K by allowing them to pass through the holes 611M. It is also possible to easily arrange the central lead wire 421M within the cutout 612M.

In order to attach the first insulating sheet portion 25M to the inside of the base groove portion 52M, the cutout 612M may be used in a positioning work. More specifically, the position of an arbitrary region of the base member and the position of the cutout 612M are preferably decided by using a jig. Then, the first insulating sheet portion 25M is attached to the inside of the base groove portion 52M. By doing so, the first insulating sheet portion 25M can be accurately attached to the inside of the base groove portion 52M.

The holes 611M shown in FIG. 24 may be replaced by a pair of cutouts, and the cutout 612M shown in FIG. 24 may be replaced by a hole. That is to say, a single hole may be arranged between a pair of cutouts. In this way, the first overhang portion may include both a hole (holes) and a cutout (cutouts). Similarly, the second overhang portion may include both a hole (holes) and a cutout (cutouts).

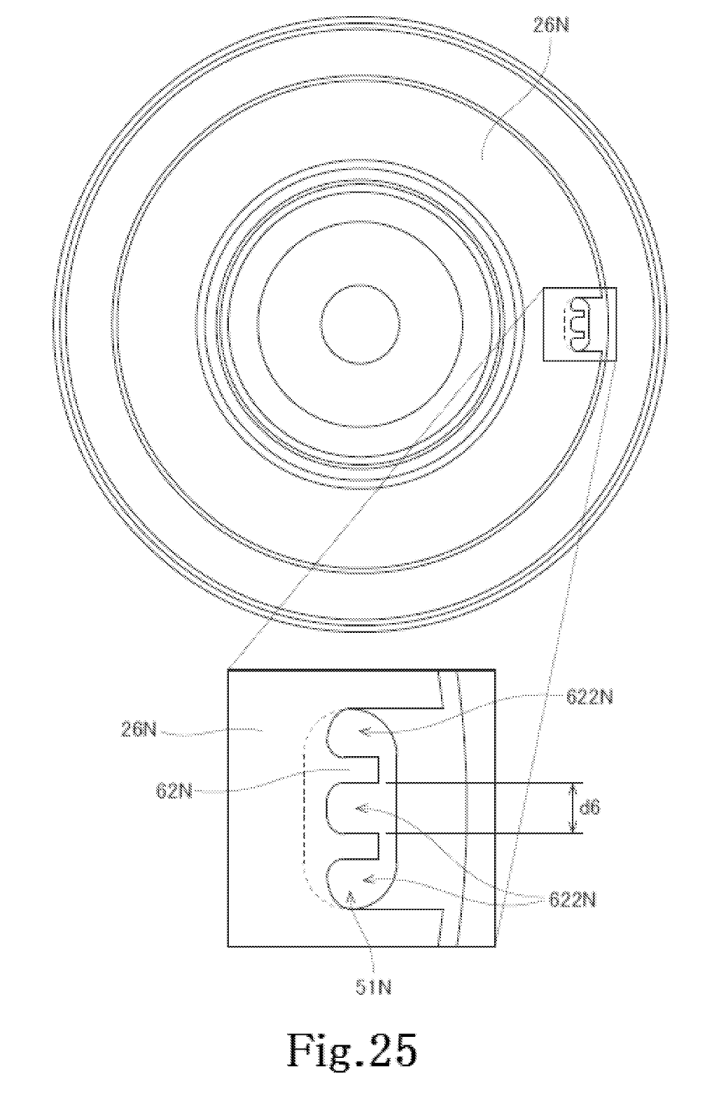

FIG. 25 is a partial plan view of a base member according to a further modified example of a preferred embodiment of the present invention. In the example shown in FIG. 25, the second overhang portion 62N of the second insulating sheet portion 26N preferably includes three cutouts 622N. The width d6 of the three cutouts 622N is larger than the diameter of the three lead wires. The three lead wires are led out from the upper side of the inner bottom portion into the base through-hole 51N through the cutouts 622N. This preferably makes it possible to easily distinguish the three lead wires led out toward the lower surface of the base member 21J. Accordingly, during the manufacture of the spindle motor, the three lead wires can be respectively connected to the three land portions without mistake.

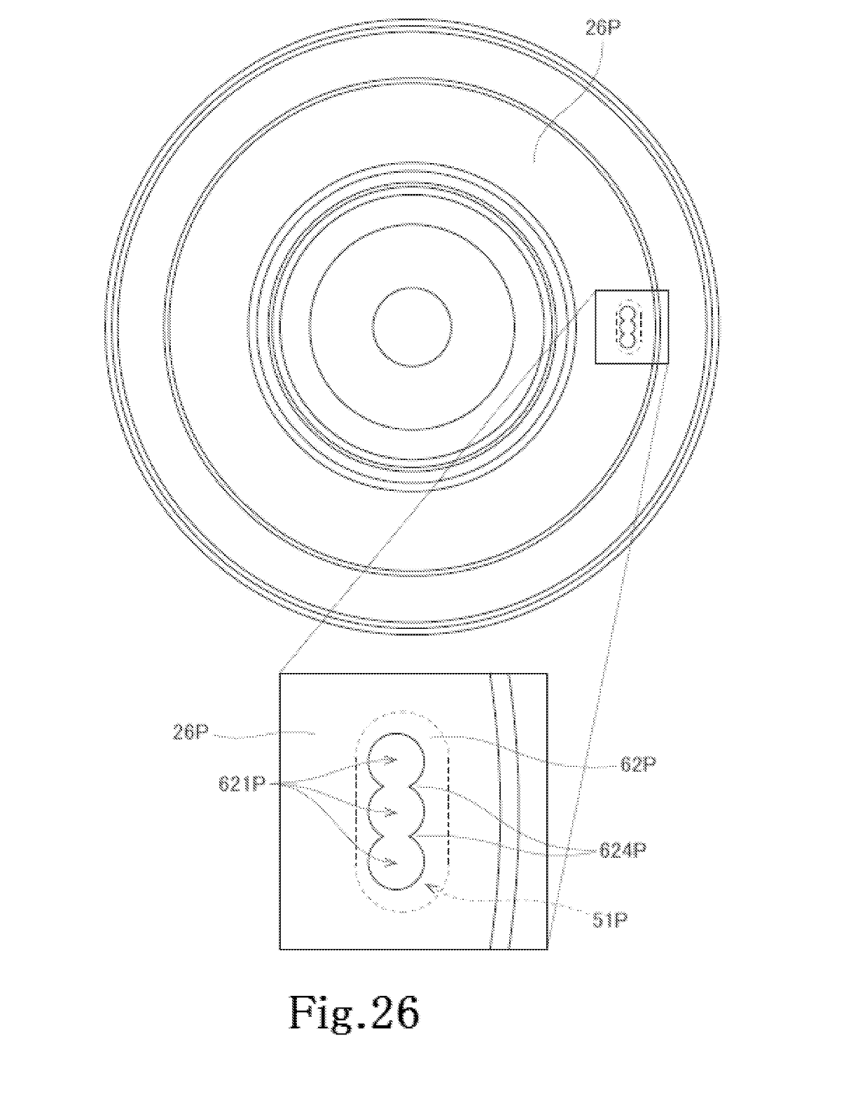

FIG. 26 is a partial plan view of a base member according to a further modified example of a preferred embodiment of the present invention. In the example shown in FIG. 26, the second overhang portion 62P of the second insulating sheet portion 26P preferably includes three holes 621P. However, the three holes 621P are preferably not isolated from one another such that adjoining holes 621P are connected to each other. The second overhang portion 62P of the second insulating sheet portion 26P preferably further includes projections 624P provided between the adjoining holes 621P. The three lead wires are led out from the upper side of the inner bottom portion into the base through-hole 51P through the holes 621P. The projections 624P restrain the positions of the lead wires and position the lead wires within the respective holes 621P. This makes it possible to easily distinguish the three lead wires led out toward the lower surface of the base member from each other. Accordingly, during the manufacture of the spindle motor, the three lead wires can be respectively connected to the three land portions without mistake.

Further, the first overhang portion may include a plurality of holes connected to one another as in the example shown in FIG. 26.

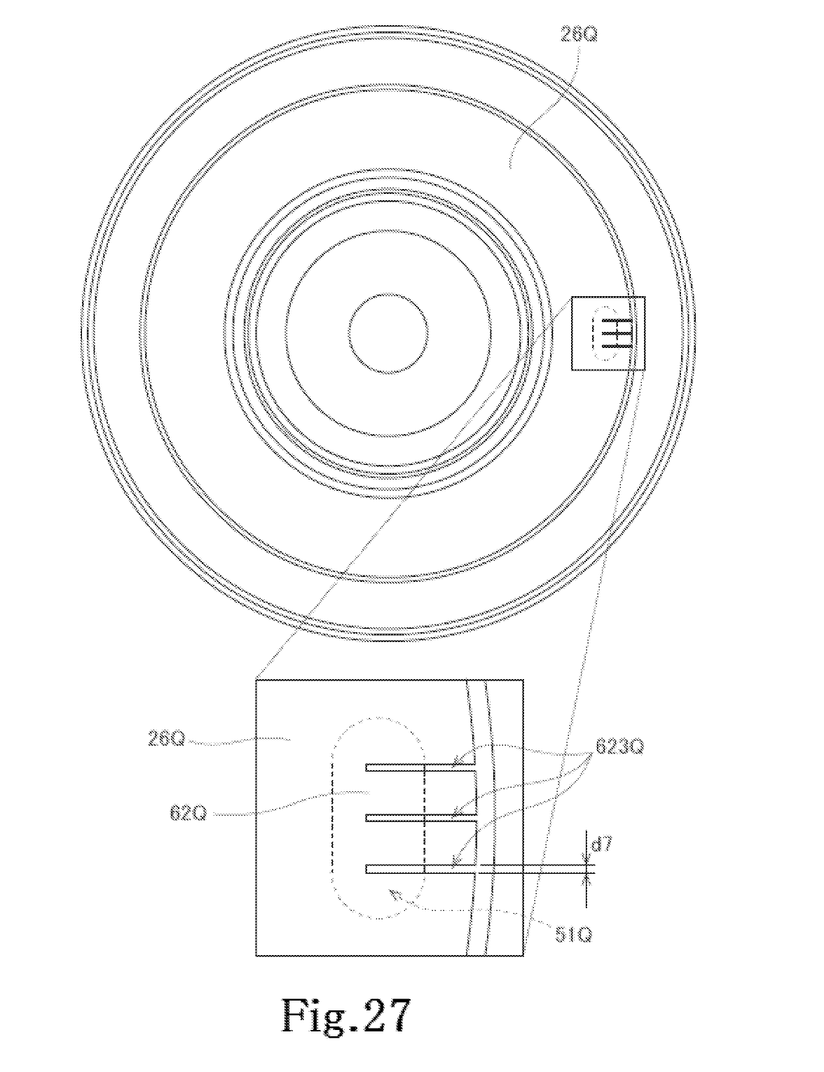

FIG. 27 is a partial bottom view of a base member according to a further modified example of a preferred embodiment of the present invention. In the example shown in FIG. 27, the second overhang portion 62Q of the second insulating sheet portion 26Q preferably includes three slits 623Q. The respective slits 623Q linearly extend from the radial outer edge of the second insulating sheet portion 26Q toward the radially inner side. The width d7 of the three slits 623Q is smaller than the diameter of the lead wires.

The three lead wires are led out from the upper side of the inner bottom portion into the base through-hole 51Q through the slits 623Q. This preferably makes it possible to easily distinguish the three lead wires led out toward the lower surface of the base member from each other. Accordingly, during the manufacture of the spindle motor, the three lead wires can be respectively connected to the three land portions without mistake. In the example shown in FIG. 27, the three lead wires can be respectively inserted into the slits 623Q. This preferably makes it possible to stably position the respective lead wires in place.

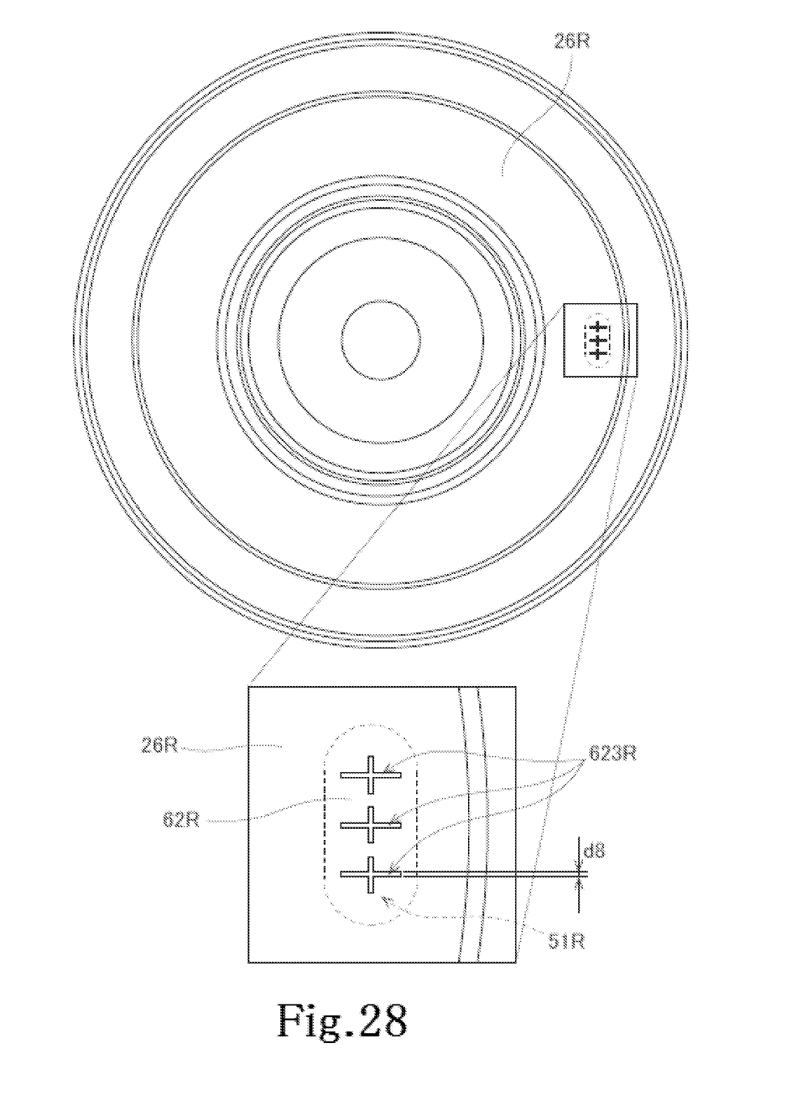

FIG. 28 is a partial bottom view of a base member according to a further modified example of a preferred embodiment of the present invention. In the example shown in FIG. 28, the second overhang portion 62R of the second insulating sheet portion 26R preferably includes three slits 623R. Each slit 623R is preferably defined by cutting the second overhang portion 62R in a cross shape. The width d8 of the three slits 623R is smaller than the diameter of the lead wires.

The three lead wires are led out from the upper side of the inner bottom portion into the base through-hole 51R through the slits 623R. This preferably makes it possible to easily distinguish the three lead wires led out toward the lower surface of the base member from each other. Accordingly, during the manufacture of the spindle motor, the three lead wires can be respectively connected to the three land portions without mistake. In the example shown in FIG. 28, the three lead wires can be respectively inserted into the slits 623R. This preferably makes it possible to stably position the respective lead wires in place.

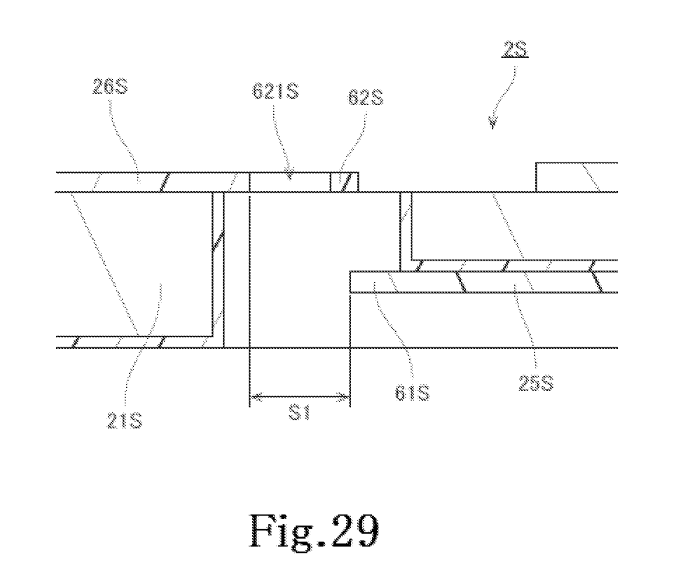

FIG. 29 is a partial vertical sectional view of a stationary unit 2S according to a further modified example of a preferred embodiment of the present invention. In the example shown in FIG. 29, none of holes, cutouts, or slits are defined in the first overhang portion 61S of the first insulating sheet portion 25S. On the other hand, holes 621S are defined in the second overhang portion 62S of the second insulating sheet portion 26S. The radial inner ends of the holes 621S of the second overhang portion 62S are positioned radially inward of the radial inner end of the first overhang portion 61S. Thus, when the base member 21S is seen in the axial direction, an axially communicating space S1 can be defined between the radial inner end of the first overhang portion 61S and the radial inner ends of the holes 621S of the second overhang portion 62S. This makes it possible to easily pass the lead wires through the space S1.

In the example shown in FIG. 29, the second overhang portion 62S may be provided with cutouts or slits instead of the holes 621S. In that case, it is preferred that the radial inner ends of the cutouts or the slits of the second overhang portion 62S are positioned radially inward of the radial inner end of the first overhang portion 61S. By doing so, as described above, an axially communicating space is defined between the radial inner end of the first overhang portion 61S and the radial inner ends of the cutouts or the slits of the second overhang portion 62S. This preferably makes it possible to easily pass the lead wires through the space.

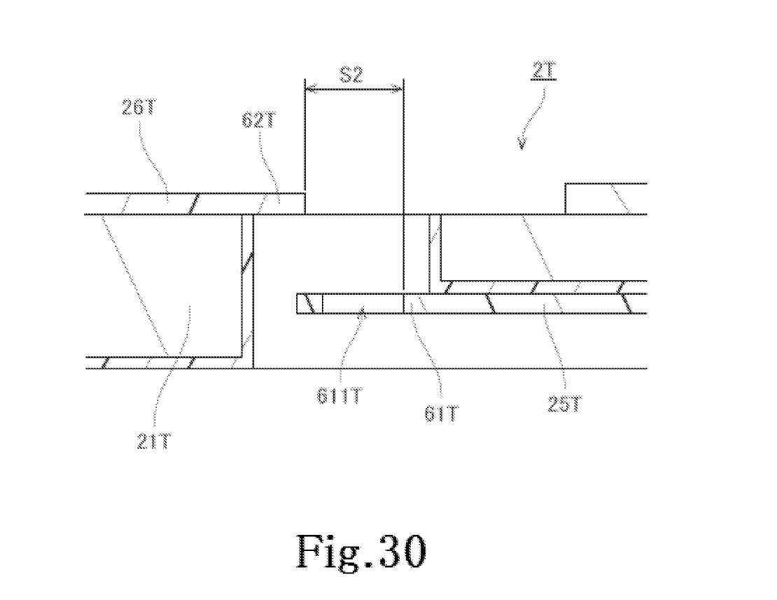

FIG. 30 is a partial vertical sectional view of a stationary unit 2T according to a further modified example of a preferred embodiment of the present invention. In the example shown in FIG. 30, holes 611T are preferably defined in the first overhang portion 61T of the first insulating sheet portion 25T. On the other hand, none of holes, cutouts, or slits are defined in the second overhang portion 62T of the second insulating sheet portion 26T. The radial outer ends of the holes 611T of the first overhang portion 61T are positioned radially outward of the radial outer end of the second overhang portion 62T. Thus, when the base member 21T is seen in the axial direction, an axially communicating space S2 can be defined between the radial outer ends of the holes 611T of the first overhang portion 61T and the radial outer end of second overhang portion 62T. This preferably makes it possible to easily pass the lead wires through the space S2.

In the example shown in FIG. 30, the first overhang portion 61T may alternatively be provided with cutouts or slits instead of the holes 611T. In that case, it is preferred that the radial outer ends of the cutouts or the slits of the first overhang portion 61T are positioned radially outward of the radial outer end of the second overhang portion 62T. By doing so, as described above, an axially communicating space can be defined between the radial outer ends of the cutouts or the slits of the first overhang portion 61T and the radial outer end of the second overhang portion 62T. This makes it possible to easily pass the lead wires through the space.

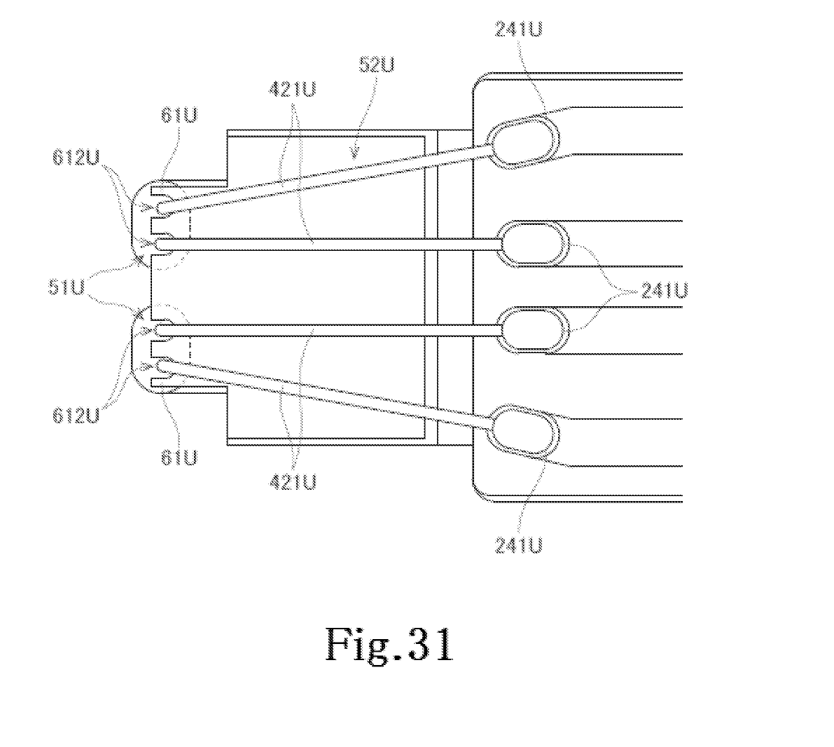

FIG. 31 is a partial bottom view of a base member according to a further modified example of a preferred embodiment of the present invention. In the example shown in FIG. 31, the base member preferably includes two base through-holes 51U. A pair of lead wires 421U are led out through each of the base through-holes 51U. In the example shown in FIG. 31, the first overhang portion 61U preferably includes four cutouts 612U. The four lead wires 421U extending through the two base through-holes 51U are led out into the base groove portion 52U through the respective cutouts 612U. This makes it possible to easily distinguish the four lead wires 421U led out toward the lower surface of the base member from each other. Accordingly, during the manufacture of the spindle motor, the four lead wires 421U can preferably be respectively connected to four land portions 241U without mistake.

As mentioned above, the number of the base through-hole of the base member may be two or more. If two or more lead wires are led out through at least one base through-hole, it is possible to reduce the number of the base through-hole as compared with a case where the respective lead wires are led out from different base through-holes. This preferably makes it possible to minimize or prevent a reduction in the rigidity of the base member. If two or more lead wires led out through the base through-hole are made to pass through the respective holes, cutouts or slits, it is possible to easily distinguish the respective lead wires from each other.

In the aforementioned preferred embodiments, one lead wire preferably is allowed to pass through one hole, cutout or slit. Alternatively, two or more lead wires may be allowed to pass through one hole, cutout or slit. For example, if one wishes to reliably identify only one of the three lead wires, the relevant one of the lead wires may be allowed to pass through one hole, cutout or slit while allowing the remaining two lead wires to pass through the other hole, cutout or slit.

In the aforementioned fourth preferred embodiment and the respective modified examples thereof, the insulating portion is preferably arranged between the first insulating sheet portion and the inner bottom portion. However, the present invention is not limited thereto. For example, the insulating portion may be omitted as long as the contact of the lead wires with the base member can be prevented by the first insulating sheet portion.

The circuit substrate may extend to the lower surface of the ring-shaped wall portion. The land portions may be arranged in the portion of the circuit substrate positioned on the lower surface of the ring-shaped wall portion, and the lead wires may be soldered to the land portions.

Moreover, the circuit substrate may not necessarily be a flexible printed substrate. The circuit substrate may be, e.g., a rigid substrate such as, for example, a connector or the like.

The spindle motor of the various preferred embodiments of the present invention can be applied to different kinds of disk drive apparatuses. The disk drive apparatus may be the one that rotates a disk other than the magnetic disk, e.g., an optical disk. According to the preferred embodiments of the present invention, it is possible to minimize or prevent a reduction in the rigidity of the base member while making the disk drive apparatus thinner in the axial direction. Accordingly, the preferred embodiments of the present invention are particularly useful in a spindle motor included in a disk drive apparatus for a thin notebook-type PC or a tablet-type PC.

In the aforementioned preferred embodiments, description has been made of a so-called shaft rotating type motor in which a sleeve belongs to a stationary unit with a shaft belonging to a rotary unit. However, the motor of the preferred embodiments of the present invention may be a so-called shaft fixing type motor in which a shaft belongs to a stationary unit with a sleeve belonging to a rotary unit.

The specific shapes of the respective components may differ from those shown in the respective figures of the subject application. The respective components of the preferred embodiments and the modified examples described above may be appropriately combined unless a conflict arises.

While preferred embodiments of the present invention and modifications thereof have been described above, it is to be understood that variations and modifications will be apparent to those skilled in the art without departing from the scope and spirit of the present invention. The scope of the present invention, therefore, is to be determined solely by the following claims.

What is claimed is:

1. A spindle motor, comprising:
a stationary unit; and
a rotary unit supported to rotate about a center axis extending up and down; wherein
the stationary unit includes a base member made of metal, an armature provided with a plurality of coils and positioned above the base member, and a circuit substrate arranged on a lower surface of the base member;
the rotary unit includes a magnet opposed to the armature with a gap therebetween;
the base member includes a ring-shaped bottom portion positioned below the armature, at least one base through-hole extending through the bottom portion and a base groove portion arranged on a lower surface of the bottom portion to extend radially outward from a lower end portion of the base through-hole;
a first insulating sheet portion, which is defined by a portion of the circuit substrate or a member of the circuit substrate, is arranged on a bottom surface of the base groove portion;
a second insulating sheet portion is arranged on an upper surface of the bottom portion;
the first insulating sheet portion or the second insulating sheet portion includes an overhang portion overlapping with a lower opening or an upper opening of the base through-hole when seen in a plan view;
a plurality of lead wires electrically connected to the coils extends from the coils;
the overhang portion includes at least one hole, at least one cutout, or at least one slit, through each of which at least one of the lead wires passes, a total number of the at least one hole, the at least one cutout, or the at least one slit is two or more; and
the lead wires are arranged to pass through the upper opening of the base through-hole, the overhang portion, and the lower opening of the base through-hole and are arranged to extend to the circuit substrate through the base groove portion, the lead wires connected to the circuit substrate.

2. The spindle motor of claim 1, wherein
the overhang portion includes a first overhang portion defined in the first insulating sheet portion and a second overhang portion defined in the second insulating sheet portion;
only one of the first overhang portion and the second overhang portion includes the at least one hole, the at least one cutout, or the at least one slit.

3. The spindle motor of claim 2, wherein
the second overhang portion includes the at least one hole, the at least one cutout, or the at least one slit; and
radial inner ends of the at least one hole, the at least one cutout, or at least one slit of the second overhang portion are positioned radially inward of a radial inner end of the first overhang portion.

4. The spindle motor of claim 2, wherein
the first overhang portion includes the at least one hole, at least one cutout, or at least one slit; and
radial outer ends of the at least one hole, the at least one cutout, or the at least one slit of the first overhang portion are positioned radially outward of a radial outer end of the second overhang portion.

5. The spindle motor of claim 1, wherein
the overhang portion includes a first overhang portion defined in the first insulating sheet portion and a second overhang portion defined in the second insulating sheet portion;
each of the first overhang portion and the second overhang portion includes the at least one hole, the at least one cutout, or the at least one slit; and
the at least one hole, the at least one cutout, or the at least one slit of the first overhang portion axially overlap with the at least one hole, the at least one cutout, or the at least one slit of the second overhang portion.

6. The spindle motor of claim 1, wherein at least one of the lead wires makes contact with the overhang portion.

7. The spindle motor of claim 1, wherein the overhang portion includes the at least one hole or the at least one cutout, and a minimum diameter of the at least one hole or a minimum width of the at least one cutout is larger than the diameter of the lead wires.

8. The spindle motor of claim 1, wherein a circumferential maximum width of the at least one slit is smaller than the diameter of the lead wires.

9. The spindle motor of claim 1, wherein the overhang portion includes the at least one hole and the at least one cutout.

10. The spindle motor of claim 9, wherein the overhang portion includes two of the at least one hole arranged at peripheral sides and one of the at least one cutout positioned between the two of the at least one hole.

11. The spindle motor of claim 10, wherein a minimum diameter of the two of the at least one hole and a minimum width of the at least one cutout are larger than a diameter of the lead wires.

12. The spindle motor of claim 11, wherein at least one of the lead wires makes contact with the overhang portion.

13. The spindle motor of claim 1, wherein the lead wires passes through the at least one hole, the at least one cutout, or the at least one slit, respectively.

14. The spindle motor of claim 1, wherein the stationary unit further includes a sealing material arranged to seal the base through-hole.

15. The spindle motor of claim 14, wherein the sealing material is arranged within the base through-hole and the base groove portion.

16. The spindle motor of claim 1, wherein the first insulating sheet portion is a portion of the circuit substrate, and an axial thickness of the first insulating sheet portion is smaller than an axial thickness of a remaining portion of the circuit substrate.

17. A disk drive apparatus, comprising:
the spindle motor of claim 1;
an access unit arranged to perform at least one of information reading and writing tasks with respect to a disk supported on the rotary unit of the spindle motor; and
a housing arranged to accommodate the spindle motor and the access unit.
